(19) United States
(12) Patent Application Publication
(10) Pub. No.: US 2026/0330157 A1
(43) Pub. Date: Oct. 22, 2026

(54) Monte Carlo Tree Search-Based Decision Optimization Systems for Interspecies Communication

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 19/280,079

(22) Filed: Jul. 24, 2025

Related U.S. Application Data
(63) Continuation-in-part of application No. 19/183,828, filed on Apr. 19, 2025.
Application No. 19/183,828 is a continuation-in-part of application No. 19/177,640, filed on Apr. 14, 2025.
Application No. 19/177,640 is a continuation-in-part of application No. 19/172,638, filed on Apr. 7, 2025.
Application No. 19/172,638 is a continuation-in-part of application No. 19/094,808, filed on Mar. 28, 2025.
Application No. 19/094,808 is a continuation-in-part of application No. 19/078,192, filed on Mar. 12, 2025.

(51) Int. Cl. G06F 40/58; G06F 18/26; G06F 40/205

(52) U.S. Cl. CPC G06F 40/58; G06F 18/26; G06F 40/205

(57) ABSTRACT

Disclosed embodiments provide a system and method for Monte Carlo Tree Search-based decision optimization for interspecies communication. The Monte Carlo Tree Search-based optimization system makes use of dynamic branching and/or super-exponential regret minimization to improve decision-making in interspecies communication scenarios. Embodiments utilize a super-exponential regret condition as a criterion for initiating a model retraining sequence, while using iterative preference learning to continuously refine decision-making strategies through real-world feedback and outcomes.

### CROSS-REFERENCE TO RELATED APPLICATIONS

Priority is claimed in the application data sheet to the following patents or patent applications, each of which is expressly incorporated herein by reference in its entirety:

19/183,828

19/177,640

19/172,638

19/094,808

19/078,192

### BACKGROUND OF THE INVENTION

### Field of the Art

The present disclosure relates to the field of animal study. More specifically, the invention pertains to systems and methods that relate to interspecies communication.

### Discussion of the State of the Art

Throughout history, humans and animals have forged strong bonds that have shaped societies and daily life in profound ways. People have provided nourishment, protection, and care, while animals have offered their strength, intelligence, and loyalty to assist human efforts. Horses revolutionized travel, allowing swift movement across vast landscapes and playing a crucial role in warfare by carrying soldiers, pulling chariots, and leading cavalry charges. Mules, prized for their stamina and adaptability, were indispensable for hauling heavy loads in agriculture, mining, and construction, especially in rugged terrain where mechanical solutions fell short. Likewise, oxen served as essential work animals in early farming, steadily pulling plows and carts to cultivate fields long before modern machinery existed. Dogs have contributed in numerous ways, acting as guardians, hunters, herders, and faithful companions, ensuring security and companionship across generations. These lasting partnerships highlight the vital role of animals in human progress, helping civilizations grow, innovate, and overcome challenges.

### SUMMARY OF THE INVENTION

Disclosed embodiments provide a system and method for advanced variants of reinforcement learning and human or AI agent enhanced reinforcement learning variants of Monte Carlo Tree Search-based decision optimization for interspecies communication. The system encompasses a comprehensive suite of optimization techniques that build upon foundational Monte Carlo Tree Search (MCTS) methods, including Upper Confidence bounds applied to Trees (UCT) with super-exponential regret minimization capabilities. The disclosed optimization framework extends beyond traditional MCTS to include particle swarm optimization (PSO), genetic algorithms (GAs), tabu search methodologies, multi-armed bandit optimization approaches, simulated annealing techniques, and quantum-inspired variants of these optimization methods. These advanced techniques are often paired with reinforcement learning approaches including supervised, semi-supervised, or unsupervised learning configurations, with or without human feedback mechanisms. The system implements dynamic branching strategies and super-exponential regret minimization to improve decision-making in interspecies communication scenarios, while integrating debate-based verification at intermediate nodes and employing sliding time windows and salience-based memory for context management. Through iterative preference learning, the system continuously refines its decision-making strategies based on real-world feedback and outcomes, creating a robust optimization framework that transcends the limitations of any single algorithmic approach while maintaining the theoretical foundations and interpretability essential for complex interspecies communication tasks refine its decision-making strategies through real-world feedback and outcomes.

Disclosed embodiments can enable interspecies, human–animal, and human–robot communication through the interpretation and translation of vocalizations, neural signals, and physical movements, potentially transforming human-animal interaction by fostering deeper understanding and unprecedented collaboration. By leveraging machine learning models trained on supervised datasets, disclosed embodiments can assist humans in interpreting nuanced expressions and behaviors across species—such as deciphering a dolphin’s clicks, a dog’s bark, or subtle variations in neural signals—where such data is ethically and practically obtainable. These capabilities may improve animal welfare by enabling more personalized care, behavioral analysis, and training, while also enhancing scientific research. For example, conservationists and behavioral scientists may use the system to better interpret wildlife behavior and responses in ways previously considered infeasible. The system is further extendable to artificial agents, bots, and robotic entities by adapting the same communication interpretation framework. In contexts where vocalizations or neural signals are absent—such as in digital or robotic systems—the system utilizes internal computational state traces, including program execution logs, decision-making records, behavioral trajectories, and chain-of-thought (CoT) outputs, as proxies for communicative signals. These traces, generated during task execution or interactive processes, are analyzed to identify communicative patterns, which are then interpreted, ranked, and transformed using decision-theoretic mechanisms such as Monte Carlo Tree Search (MCTS), advanced regret minimization techniques, and debate-based validation strategies. This generalized architecture allows the system to treat different robotic or software entities analogously to biological species, supporting automated or semi-automated determination of communication capacities, reasoning proficiency, and behavioral profiles. Variants of the disclosed system and associated methods thus provide a scalable framework for cross-species and cross-agent understanding, bridging the gap between biological and artificial cognition and interaction.

According to further embodiments, the system can be extended to elucidate the communicative and cognitive capacities of artificial agents, bots, and robotic entities through automated analysis and learning processes analogous to those used for interpreting biological species. In scenarios where brainwaves or physical vocalizations are absent, the system may utilize internal state traces—such as program execution logs, decision provenance chains, behavioral trajectories, and chain-of-thought (CoT) outputs—as proxies for communicative signals. These traces, derived from the agent’s activities during task execution or decision-making, can be parsed to uncover communicative patterns that are then interpreted, ranked, and converted using decision-theoretic methods, including Monte Carlo Tree Search (MCTS), advanced regret minimization strategies, and debate-style adversarial evaluation mechanisms described elsewhere in this disclosure. In one embodiment, transformer-based architectures (such as GPT, PaLM, or similar large language models) may be employed to encode agent logs and CoT-style reasoning chains into representational formats suitable for downstream pattern recognition, behavioral modeling, and cross-agent translation. The system may further include a dynamic taxonomy induction module that infers the communicative structures of various protocols—such as multi-agent coordination protocols (MCPs) or agent-to-agent (A2A) communication schemas—using unsupervised or weakly supervised learning techniques, including clustering, causal inference models, and neuro-symbolic translation. For example, a CoT reasoning trace emitted by an autonomous drone can be automatically segmented, annotated, and interpreted as a high-level linguistic or symbolic expression describing its internal goals and decisions, which can then be translated into formats intelligible to human operators or other machine agents.

According to further embodiments, the system incorporates a Chain-of-Thought (CoT) reasoning module that explicitly models sequential reasoning processes analogous to those observed in biological cognition. This module generates intermediate reasoning steps and maintains temporal coherence using transformer-based architectures with attention mechanisms. Intermediate steps may be validated for logical consistency, and integrated backtracking mechanisms revise reasoning chains in response to new data. The module can interface with MCTS by representing reasoning steps as nodes in a decision search tree. The system’s foundational Distributed Computational Graph (DCG) architecture enables compositional extensions that support what are referred to in the literature as Tree of Thoughts (ToT), Graph of Thoughts (GoT), and Algorithm of Thoughts (AoT) capabilities. The ToT extension enables speculative branching and exploration of multiple reasoning paths in parallel, each of which is dynamically evaluated, pruned, or expanded based on heuristic or learned criteria. The GoT extension generalizes this by supporting the recombination and merging of intermediate reasoning paths through graph-based message passing, enabling flexible, non-linear reasoning workflows. The AoT extension governs the evolution of reasoning strategies themselves, allowing the system to learn, mutate, and optimize reasoning graphs over time, incorporating control flows, conditional logic, and reusable subgraph templates. All reasoning structures are expressed as composable subgraphs within the DCG runtime, where each node may represent a semantic transformation, inference operation, or query evaluation, and edges denote the flow of intermediate representations or decisions. The DCG engine maintains execution provenance and supports runtime introspection, enabling traceability, consistency checking, and coherent tracking of reasoning states across both deterministic and exploratory inference paths.

In these embodiments, all such reasoning structures are expressed as composable subgraphs within the Distributed Computational Graph (DCG) runtime, where each node may correspond to a semantic transformation, inference step, or query evaluation. Edges in the DCG represent the flow of intermediate representations or decisions, and transformation nodes may be dynamically materialized, skipped, or revised using attention-based weighting, context signals, or debate-driven feedback. The DCG engine maintains execution provenance and supports runtime introspection, enabling coherent tracking of reasoning state, validation checkpoints, and traceability for both deterministic and exploratory inference paths. The DCG engine also supports meta-reasoning through neural controllers that dynamically configure subgraph composition strategies based on task complexity, species profile, or interpretability constraints, thereby enabling adaptive traversal strategies across ToT, GoT, and AoT styles. These ToT, GoT, and AoT behaviors are thus not distinct modules but manifestations of the system’s unified orchestration substrate. This design ensures compatibility with multi-agent negotiation protocols, debate-based verification, and regret-driven search modules such as Monte Carlo Tree Search (MCTS) and Super-Exponential Regret (SER). Furthermore, because reasoning paths are maintained as explicit subgraphs, downstream modules (e.g., translators, summarizers, or planners) may consume or audit these reasoning artifacts for interpretability or for reinforcement learning signal generation.

According to further embodiments, the Chain of Thought (CoT) reasoning module described above may be extended to support additional compositional reasoning structures, including what are sometimes referred to in the literature as Tree of Thoughts (ToT), Graph of Thoughts (GoT), and Algorithm of Thoughts (AoT). In various implementations, these capabilities are enabled through the core Distributed Computational Graph (DCG) engine, which underlies the orchestration of reasoning steps, transformations, and state propagation across the system.

According to further embodiments, the system implements a Zero-shot Universal Communication Primitives (UCP) module, enabling communication with previously unknown species by decomposing signals into fundamental, species-agnostic communication primitives. This module employs hierarchical variational autoencoders (H-VAE) and meta-learning strategies such as Model-Agnostic Meta-Learning (MAML), facilitating rapid adaptation and generalization from minimal data.

According to further embodiments, the system includes an Automated Protocol Discovery System (APDS) tailored for digital entities, leveraging reverse engineering and grammar induction techniques to infer and translate between distinct computational communication protocols. Reinforcement learning guides proactive exploration of unknown protocols, storing discovered protocol structures as executable specifications for immediate integration.

According to further embodiments, the system comprises a Confidence-Aware Fuzzy Logic Approximation Engine (CAFLAE) to manage the uncertainty inherent in interpreting interspecies communications. This engine employs type-2 fuzzy logic and adaptive rule bases, propagating uncertainty through the translation pipeline and integrating possibility and necessity measures to dynamically assess interpretation confidence. The type-2 fuzzy logic framework explicitly models two levels of uncertainty: aleatory uncertainty, reflecting inherent variability in biological communication signals, and epistemic uncertainty, reflecting incomplete knowledge or ambiguity in the interpretation rules and fuzzy set definitions. CAFLAE maintains fuzzy membership functions with associated secondary membership functions, allowing it to quantify both uncertainty in the communication content and uncertainty about that uncertainty. This dual-level modeling enables the system to distinguish between natural variation in signals and gaps in species-specific behavioral knowledge. The engine dynamically refines its confidence estimates based on accumulating evidence, continuously updating both the primary fuzzy sets used for interpretation and their associated secondary sets, thus providing robust and adaptive uncertainty quantification throughout the interspecies communication process.

According to further embodiments, the system leverages Reasoning via Planning (RAP) techniques integrated with MCTS, modeling animal and artificial agent behaviors as planning tasks within partially observable Markov decision processes (POMDPs). Inverse reinforcement learning and uncertainty-aware planning simulate interactions, predicting and guiding effective communication sequences.

According to further embodiments, the system applies Continual Learning with Elastic Weight Consolidation (CL-EWC) to incrementally integrate new communication patterns without compromising existing knowledge. Employing Fisher Information Matrices and elastic regularization strategies, this approach preserves model stability during iterative learning processes.

According to further embodiments, the system includes a Self-Learning Signal Decomposition (SLSD) module utilizing neural architecture search (NAS) for automatic discovery of species-specific optimal signal-processing pipelines. Adaptive basis functions and differentiable processing components optimize signal representation, identifying novel informational structures within species-specific communication.

According to further embodiments, the system leverages Reasoning via Planning (RAP) techniques integrated with MCTS, modeling animal and artificial agent behaviors as planning tasks within partially observable Markov decision processes (POMDPs). Inverse reinforcement learning and uncertainty-aware planning simulate interactions, predicting and guiding effective communication sequences.

According to further embodiments, the system incorporates a Federated Learning Architecture (FLA) to collaboratively refine communication models across distributed sites, applying differential privacy and hierarchical aggregation methods to preserve data confidentiality and optimize bandwidth utilization.

In one embodiment, transformer-based architectures (such as GPT, PaLM, or similar large language models) may be used to encode agent logs and CoT-style reasoning chains into a representational format suitable for downstream pattern analysis and cross-agent translation. The system may include a dynamic taxonomy induction module that infers the communicative structures of various protocols, such as multi-agent coordination protocols (MCP) or agent-to-agent (A2A) communication schemas, using unsupervised learning methods, including clustering, causal inference models, or neuro-symbolic translation techniques. For example, a CoT reasoning trace emitted by an autonomous drone can be automatically segmented, annotated, and interpreted as a high-level linguistic expression describing its internal goals and decisions, which is then translated into formats intelligible to human operators or other machine agents.

In an additional embodiment, the system may use provenance-aware learning frameworks in which the justification graphs, state-action paths, or modular attention activations serve as surrogates for salience indicators. These signals can be incorporated into a multimodal temporal segmentation module, allowing the system to generate sliding time windows for context maintenance and to apply reinforcement learning with feedback (including preference learning, trajectory-level reward models, or offline RL methods) to iteratively refine its communicative interpretations. Debate-based verification can be applied to agent-trace-derived communications by instantiating multiple models with distinct ontological priors to simulate discourse over plausible interpretations, with a selector or judge module (which may be adversarial or reinforcement-guided) choosing the most likely or useful outcome.

Such embodiments allow the system to dynamically profile agents based on their communication and reasoning behaviors, and to evolve an adaptive ontology that spans biological and artificial communicative forms. The resulting inter-agent communication framework enables collaborative decision-making, goal alignment, and coordination across diverse species and entity types, contributing to the broader objective of unified interspecies and inter-agent communication and cognition modeling.

According to further embodiments, the system may incorporate Multi-agent Coordination Protocols (MCP) as both a substrate and catalyst for expanding Agent-to-Agent (A2A) communication within heterogeneous and cross-entity environments. MCPs serve as structured frameworks that govern how agents negotiate tasks, share information, resolve conflicts, and align on shared objectives. Within the disclosed system, MCPs can be learned, inferred, or synthesized by observing agent behaviors across time—particularly within collaborative or adversarial settings—and mapping those behaviors to abstract communicative intents. These protocols, once identified, may be integrated into the Monte Carlo Tree Search (MCTS)-based optimization engine, allowing the system to simulate and evaluate coordination outcomes across multiple agents using dynamically branching decision pathways governed by the rules of each discovered MCP variant.

In one embodiment, MCPs may be formalized as latent policy structures that are instantiated during inter-agent interactions and encoded using differentiable program induction methods or sequence-to-sequence neural models. The system can apply contrastive learning to distinguish between coordination schemas across agent populations, identifying when communication is governed by implicit turn-taking, distributed consensus, role-based task partitioning, or other emergent strategies. These MCP structures can then be reified as communication templates, enabling novel agents—human, animal, or synthetic—to join existing communication clusters by adapting to or negotiating protocol alignment using reinforcement learning with online or offline feedback. Through iterative CoT analysis and trace embedding, new agents can be guided into compatible communicative roles, enabling seamless integration into ongoing collaborations.

As a result, Agent-to-Agent communication is no longer limited to reactive or one-off exchanges but can evolve into sustained, protocol-aware dialog that supports both hierarchical and distributed decision-making. The disclosed system may additionally enable protocol synthesis, wherein novel MCPs are generated through adversarial self-play or debate-based protocol negotiation, allowing agents to invent or refine coordination languages tailored to specific environments or tasks. This ability to bootstrap A2A communication via MCP scaffolding not only enhances interoperability across disparate systems but also lays the groundwork for emergent inter-agent societies in which meaning, strategy, and coordination evolve in tandem with task complexity and contextual demands. These capabilities enable the system to foster adaptive, resilient communication ecosystems that scale beyond individual dyads to encompass teams, swarms, or hybrid collectives of agents and biological entities.

According to additional embodiments, the system can enable efficient online learning for artificial agents in a manner analogous to the way animals learn from experience, feedback, and environmental cues. By leveraging the structured representation of traces, provenance data, and chain-of-thought (CoT) reasoning outputs, the system can continuously extract learning signals from each agent’s own behavior as well as from interactions with other agents, humans, or environmental stimuli. These learning signals form a rich substrate of experience from which the system can generalize patterns, update internal models, and refine communicative or decision-making strategies in real time. In contrast to traditional offline model training pipelines, the system’s architecture allows for continuous, adaptive learning through reinforcement mechanisms that are informed not only by reward signals but also by interpretive traces of internal justification and historical provenance.

In one embodiment, each agent’s execution trace and CoT output—comprising sequences of planned actions, branching justifications, and retrospective evaluations—can be parsed and embedded into latent representations that capture both procedural knowledge and meta-cognitive structures. These representations can be temporally indexed and aligned with observed environmental feedback or social reinforcement (e.g., approval from a coordinating agent), forming a time-linked causal chain between intention, action, and outcome. Through techniques such as memory-augmented neural networks or attention-based transformer architectures, the system can selectively attend to salient past experiences, enabling agents to recall and reuse useful reasoning patterns in similar future scenarios. In this way, learning is not merely reactionary but grounded in a structured epistemic framework that supports generalization, abstraction, and explanation.

Furthermore, the system may apply meta-learning approaches to accelerate adaptation across novel contexts. For instance, using few-shot fine-tuning guided by prior traces, an agent may infer optimal behavior in a new cooperative task without extensive retraining. When conflicts or uncertainties arise during learning, debate-based modules can simulate alternative interpretations of the agent’s own CoT reasoning and select the hypothesis that best aligns with both external feedback and internal consistency constraints. Over time, this dynamic interplay between CoT-based introspection, trace-based self-monitoring, and external reinforcement fosters a robust online learning loop, enabling agents to grow in capability in a manner parallel to biological learning—via feedback-rich, context-sensitive adaptation. This not only enhances task performance but also facilitates transparent, explainable decision-making in systems operating within complex, multi-agent, or human-facing environments.

Beyond human-animal interaction, disclosed embodiments can enable different animal species to communicate directly, possibly unlocking new ecological insights and cooperative behaviors. For instance, domesticated and wild species could coordinate their survival strategies, leveraging shared knowledge to navigate complex environments. Disclosed embodiments can further utilize search optimization systems such as Monte Carlo Tree Search-based optimization systems, along with dynamic branching and super-exponential regret minimization, to refine decision-making in these interactions, thus helping the system adapt to ever-changing communication patterns while reducing errors in interpretation. Additionally, incorporating a debate-based verification mechanism (such as via complementary use Generative Adversarial Networks or Judge supervised LLM vs LLM or LLM vs other algo (e.g. diffusion, VAE, etc) debate processes) promotes translations that are reliable, filtering out inaccuracies through simulated discourse between competing models or ontologies (e.g. since approaches can debate the translation between symbolic representations of knowledge or the knowledge itself or the linguistic representation of such concepts or embodiments of concepts).

Disclosed embodiments can provide functionality far beyond mere translation. One or more embodiments can promote ethical advancements by fostering mutual understanding across or between, animals, robots/computers and humans for myriad purposes including general collaboration and interaction, reducing conflict between humans and animals and robots or virtual entities, and even reshaping industries such as agriculture, conservation, and animal-assisted therapy. Disclosed embodiments can potentially serve to enable service animals being able to express their needs with pinpoint accuracy or allow researchers engaging in meaningful exchanges with marine life to better protect fragile ecosystems. By bridging the cognitive divide between species, disclosed embodiments can enable a fundamental shift in how living beings coexist, collaborate, and evolve together.

Disclosed embodiments can harness the vastly untapped resource of animal intelligence to perform collaborative task execution by facilitating improved interspecies communication and task coordination. Such tasks can include search and rescue, exploration, surveillance, and more. Moreover, multiple species of animals, such as whales, dolphins, and octopuses can collaborate with each other, humans, and/or robots on these types of tasks, as well as others.

According to an embodiment, there is provided a system for AI-enabled interspecies communication, comprising a computing device including at least a memory and a processor, and a plurality of programming instructions that, when executed by the processor, cause the computing device to receive first communication data from a first species and second communication data from a second species. The system processes the first and second communication data using one or more machine-learning systems configured to parse the data to derive one or more linguistic or communication patterns. These patterns are then evaluated using optimization and search strategies, including Monte Carlo Tree Search (MCTS), Upper Confidence bounds applied to Trees (UCT) with advanced regret minimization techniques, particle swarm optimization (PSO), genetic algorithms (GAs), tabu search, multi-armed bandit optimization, simulated annealing, quantum-inspired variants thereof, or combinations of these methods. Based on the evaluation, the patterns are ranked, and the highest-ranked pattern corresponding to the first species is converted into a corresponding pattern for the second species using one or more conversion models. Likewise, the highest-ranked pattern corresponding to the second species is converted into a corresponding pattern for the first species. The resulting converted patterns are then transmitted to respective output elements, with the converted pattern for the first species delivered to a first output element and the converted pattern for the second species delivered to a second output element.

According to another preferred embodiment, there is provided a method for AI-enabled interspecies communication, comprising: receiving first communication data from a first species; receiving second communication data from a second species; processing the first communication data and second communication data through a machine-learning system, wherein the machine-learning system is configured to: parse the first communication data and second communication data to derive one or more linguistical patterns; perform a Monte Carlo Tree Search (MCTS) process to evaluate the one or more linguistical patterns that were derived; rank the one or more linguistical patterns based on the evaluating; input this linguistical pattern to the conversion model to convert a highest ranked linguistical pattern corresponding to the first species to derive a converted linguistical pattern corresponding to the second species; input this linguistical pattern to the conversion model to convert a highest ranked linguistical pattern corresponding to the second species to derive a converted linguistical pattern corresponding to the first species; send the converted linguistical pattern corresponding to the first species to a first output element; and send the converted linguistical pattern corresponding to the second species to a second output element.

According to another embodiment, at least one of the first output element and the second output element comprise an underwater transducer.

According to another embodiment, at least one of the first output element and the second output element comprise an electronic display.

According to another embodiment, at least one of the first output element and the second output element comprise an acoustic transducer.

According to another embodiment, the plurality of programming instructions further includes instructions to perform a super-exponential regret minimization process as part of the MCTS process.

According to another embodiment, the plurality of programming instructions further includes instructions to: obtain first vocalization data from the first species; obtain second vocalization data from the second species; obtain first brainwave data from the first species; obtain second brainwave data from the second species; obtain first movement data from the first species; obtain second movement data from the second species; and provide the first vocalization data, second vocalization data, first brainwave data, second brainwave data, first movement data, second movement data, as input data to a Multimodal Temporal Segmentation Module (MTSM) to generate one or more sliding time windows pertaining to the input data.

According to another embodiment, the plurality of programming instructions further includes instructions to render and present a real-time orchestration dashboard on an electronic display that is coupled to the system, wherein the real-time orchestration dashboard includes a rendering of a geospatial view, a behavioral stream display, and a multimodal correlation display.

According to another embodiment, the plurality of programming instructions further includes instructions to render and present an alert message on the real-time orchestration dashboard.

According to another embodiment, the plurality of programming instructions further includes instructions to render and present a recommendation action on the real-time orchestration dashboard, wherein the recommendation action is based on the alert message.

According to another embodiment, the plurality of programming instructions further includes instructions to send the converted linguistical pattern corresponding to the first species and send the converted linguistical pattern corresponding to the second species using a half-duplex process.

According to another embodiment, the plurality of programming instructions further includes instructions to implement a turn-based half-duplex process.

According to another embodiment, there is provided a method that includes performing a super-exponential regret minimization process as part of the MCTS process.

According to another embodiment, there is provided a method that includes rendering and presenting a real-time orchestration dashboard on an electronic display, wherein the real-time orchestration dashboard includes a rendering of a geospatial view, a behavioral stream display, and a multimodal correlation display.

According to another embodiment, there is provided a non-transitory, computer-readable medium comprising programming instructions for an electronic computation device executable by a processor to cause the electronic computation device to: receive first communication data from a first species; receive second communication data from a second species; process the first communication data and second communication data through a machine-learning system, wherein the machine-learning system is configured to: parse the first communication data and second communication data to derive one or more linguistical patterns; perform a Monte Carlo Tree Search (MCTS) process to evaluate the one or more linguistical patterns that were derived; rank the one or more linguistical patterns based on the evaluating; input this linguistical pattern to the conversion model to convert a highest ranked linguistical pattern corresponding to the first species to derive a converted linguistical pattern corresponding to the second species; input this linguistical pattern to the conversion model to convert a highest ranked linguistical pattern corresponding to the second species to derive a converted linguistical pattern corresponding to the first species; send the converted linguistical pattern corresponding to the first species to a first output element; and send the converted linguistical pattern corresponding to the second species to a second output element.

### BRIEF DESCRIPTION OF THE DRAWING FIGURES

FIG. 1 shows an exemplary environment in which a system for multimodal orchestration for human-animal-robot collaborative task execution can be used, in accordance with one or more embodiments.

FIG. 2 is a block diagram illustrating components of a system for multimodal orchestration for human-animal-robot collaborative task execution, in accordance with one or more embodiments.

FIG. 3 is a block diagram illustrating details of a neural interface component, in accordance with one or more embodiments.

FIG. 4 is a block diagram illustrating details of a translation processing unit, in accordance with one or more embodiments.

FIG. 5 is a block diagram illustrating details of a multi-species output unit, in accordance with one or more embodiments.

FIG. 6 is a block diagram illustrating details of a multi-species collaboration layer, in accordance with one or more embodiments.

FIG. 7 is a block diagram illustrating details of a large language model (LLM), other AI, symbolic reasoning, or neurosymbolic orchestration system, in accordance with one or more embodiments.

FIG. 8 is a block diagram illustrating details of a Simultaneous Localization and Mapping (SLAM) system, in accordance with one or more embodiments.

FIG. 9 is a block diagram illustrating an exemplary training system for integrated multimodal sensor processing for cross-species state estimation, in accordance with one or more embodiments.

FIG. 10 shows an exemplary environment in which Monte Carlo tree search-based decision optimization systems for interspecies communication can be used, in accordance with one or more embodiments.

FIG. 11 shows details of an information dashboard used in Monte Carlo tree search-based decision optimization systems for interspecies communication, in accordance with one or more embodiments.

FIG. 12 is a block diagram illustrating components of a system for interspecies communication, in accordance with one or more embodiments.

FIG. 13 shows exemplary animal brainwaves that can be analyzed using one or more embodiments.

FIG. 14 is a diagram illustrating sliding time windows used in multimodal trend analysis, in accordance with one or more embodiments.

FIG. 15 shows an exemplary environment in which Monte Carlo tree search-based decision optimization systems for interspecies communication can be used, in accordance with one or more embodiments.

FIG. 16 shows a block diagram of an exemplary non-invasive sensor, in accordance with one or more embodiments.

FIG. 17 is a flow diagram illustrating an exemplary method for Monte Carlo tree search-based decision optimization for interspecies communication, according to one or more embodiments.

FIG. 18 is a flow diagram illustrating an exemplary method for training a system for Monte Carlo tree search-based decision optimization for interspecies communication, according to one or more embodiments.

FIG. 19 illustrates an exemplary computing environment on which an embodiment described herein may be implemented, in full or in part.

FIG. 20 is a block diagram illustrating a type-2 fuzzy logic architecture for a Confidence-Aware Fuzzy Logic Approximation Engine (CAFLAE), in accordance with one or more embodiments.

FIG. 21 is a flow diagram illustrating an uncertainty propagation process used in a Confidence-Aware Fuzzy Logic Approximation Engine (CAFLAE), in accordance with one or more embodiments.

FIG. 22 is a conceptual diagram illustrating the modeling and handling of aleatory and epistemic uncertainty within the Confidence-Aware Fuzzy Logic Approximation Engine (CAFLAE), in accordance with one or more embodiments.

FIG. 23 is a block diagram illustrating an integration framework for chain of thought (CoT), Tree of Thoughts (ToT), Graph of Thoughts (GoT), and Algorithm of Thoughts (AoT) with a distributed computational graph (DCG) and Monte Carlo Tree Search (MCTS), in accordance with one or more embodiments.

FIG. 24 is a block diagram illustrating a multi-species machine learning (ML) architecture for interspecies communication, in accordance with one or more embodiments.

The drawings are not necessarily to scale. The drawings are merely schematic representations, not intended to portray specific parameters of the disclosed embodiments. The drawings are intended to depict only typical embodiments of the invention, and therefore should not be considered as limiting in scope.

### DETAILED DESCRIPTION OF THE INVENTION

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to use in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “Cetacean” refers to a marine mammal belonging to the order Cetacea, which includes animals like whales, dolphins, and porpoises. These creatures are fully aquatic and are characterized by their streamlined bodies, lack of hind limbs, and adaptations for life in the water, such as flippers, tail flukes, and blowholes for breathing at the surface.

As used herein, “Monte Carlo Tree Search” (MCTS) is an algorithm used for decision-making in complex environments, particularly in game-playing and AI planning. It explores possible future actions by simulating random plays and incrementally refining its choices based on statistical outcomes. MCTS balances exploration and exploitation, progressively favoring more promising moves while still testing new possibilities.

As used herein, “large language model” (LLM) is a type of artificial intelligence model, typically based on deep learning, that is designed to process, understand, and generate human language. These models are trained on massive datasets of text, enabling them to predict the likelihood of sequences of words, understand context, and produce coherent and contextually relevant responses. Variants include a range of attention and attentionless approaches such as Transformers, Mamba, Hyena, Titans, Megolodon, or DeepSeekR1 that have varying degrees of pre-training, fine-tuning and reasoning capabilities.

As used herein, “Canine” refers to members of the Canidae family, which includes domestic dogs (Canis lupus familiaris), and particularly to domestic dogs.

### Conceptual Architecture

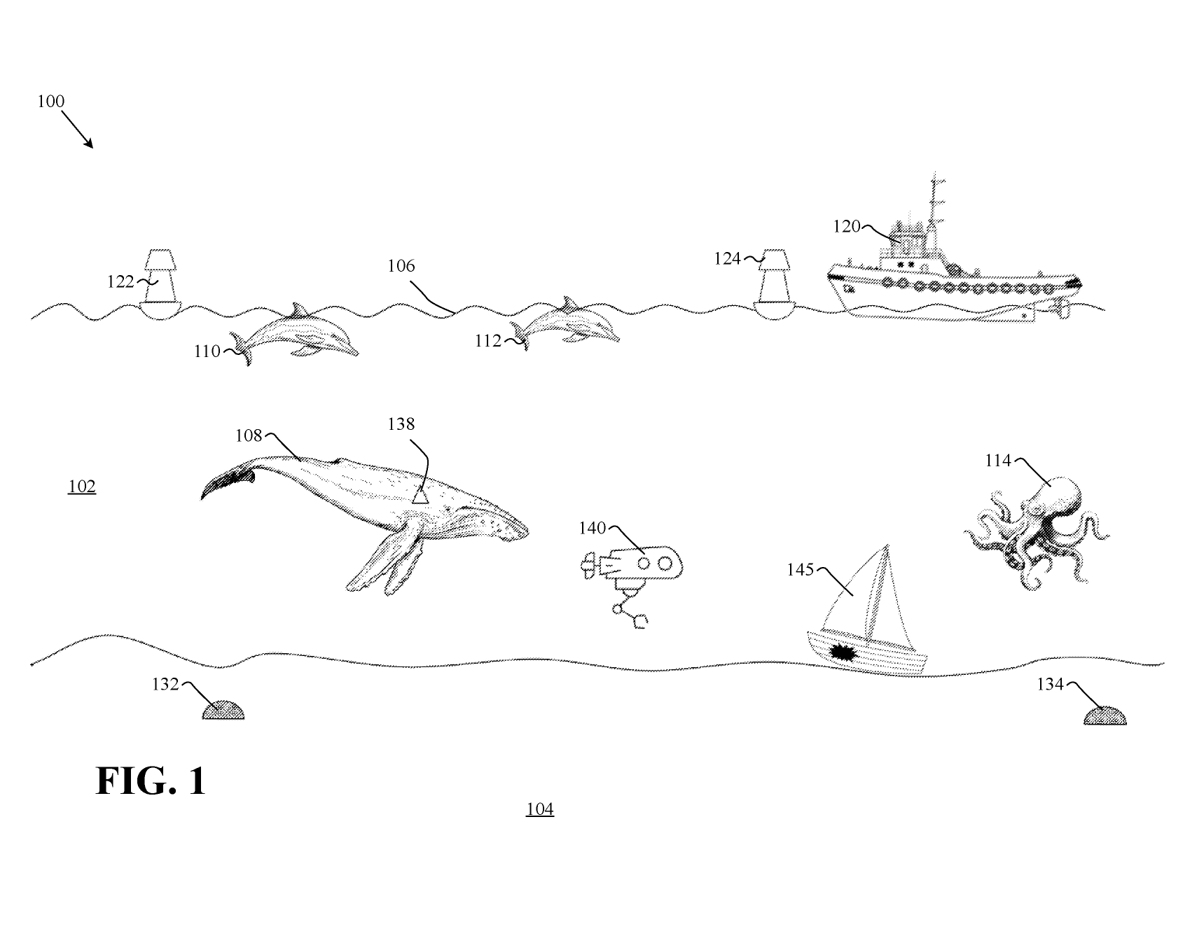

FIG. 1 shows an exemplary environment in which a system for multimodal orchestration for human-animal-robot collaborative task execution can be used, in accordance with one or more embodiments. Environment 100 can include a large body of water 102. However, disclosed embodiments are not limited to use in aquatic environments. Some embodiments may interact with land animals and/or flying animals and may be used in environments involving aquatic, land-based, and/or above-ground environments. Large body of water 102 can include an ocean (e.g., Pacific Ocean, Atlantic Ocean, etc.), a sea, (e.g., Mediterranean Sea, Baltic Sea, etc.), a lake (e.g., Lake Superior, Lake Victoria, etc.), a river (e.g., Mississippi River), a gulf (e.g., Gulf of Mexico), a bay (e.g., Hudson Bay), a strait (e.g., Bering Strait), a fjord, an estuary, a man-made reservoir, and/or other suitable large body of water.

The environment 100 can include one or more buoys, indicated as 122 and 124 in environment 100. In one or more embodiments, the buoys (122, 124) float on the surface 106 of the body of water 102, and can include a variety of equipment for sensing, receiving, storing, and/or transmitting data, as well as one or more output devices. The buoys can include one or more atmospheric sensors. The atmospheric sensors can include a wind speed sensor, wind direction sensor, air temperature sensor, air humidity sensor, barometric pressure sensor, solar radiation sensor, microphone, and/or other suitable atmospheric sensors.

The buoys can include one or more water-based sensors. The water-based sensors can include temperature sensors (to measure surface water temperature), salinity sensors (to determine the salt content of the water), pH sensors (to measure acidity/alkalinity), dissolved oxygen sensors (to monitor oxygen levels for aquatic life), and/or turbidity sensors (to measure water clarity). The water-based sensors may include wave height and direction sensors to measure ocean swell and surface conditions, current velocity sensors (to track underwater currents), tide and sea level sensors, and/or chlorophyll sensors (to estimate plankton levels and water productivity). The water-based sensors may include underwater microphones to detect underwater sounds from aquatic life and/or marine craft. The buoys can include one or more meteorological sensors, such as rain gauges and/or lightning detectors.

The buoys can include a variety of communication equipment, such as satellite transmitters (e.g., Iridium) for long-range communication. The buoys may include cellular modems, suitable for communication within areas of network coverage. The buoys may include radio transmitters to enable short-range transmission for local stations or vessels. The buoys may include Wi-Fi and/or Bluetooth modules to support local data access when in close proximity. The buoys may include GPS receivers to track buoy position and movement. Other communication systems may be present on the buoys in one or more embodiments. The buoys can include a wide variety of output devices, including, but not limited to, signal lights, audible alarms, underwater speakers, out-of-water speakers, and/or digital displays. The buoys can include a variety of computing devices, such as embedded microcontrollers, edge processors, data loggers, and/or other suitable computing equipment. In one or more embodiments, the buoys may include AI-based edge devices for advanced tasks such as detecting patterns, identifying marine life, and/or predictive analysis.

The environment 100 may further include one or more seafloor detection devices, that are located on seafloor 104, indicated at 132 and 134. Each seafloor detection device (132, 134) can include a seismometer, hydrophone array, and a wide range of other sensors and technologies for monitoring vibrations, seismic activity, and underwater sounds. The seafloor detection device can include a broadband seismometer for capturing a wide range of seismic frequencies. The seafloor detection device can further include a short-period seismometer to focus on high-frequency vibrations. The seafloor detection device can further include one or more accelerometers for measuring ground accelerations for vibrations caused by earthquakes, underwater landslides, or human-made activities such as drilling.

The hydrophone array within the seafloor detection devices can enable detecting soundwaves from marine mammals such as whales and dolphins. Other sounds may also be detected by the hydrophone array. These sounds can include sounds from underwater explosions, ship noise, or submarine movements. One or more hydrophones within the hydrophone array may be tuned for capturing low-frequency sounds from large marine animals and/or geological events. The seafloor detection devices may further include a current meter to track underwater currents that may result from tectonic and/or seismic activity.

In one or more embodiments, the seafloor detection devices may be communicatively coupled to one or more surface devices, such as buoys (122, 124), and/or ship 120. The communicative coupling can include cables, such as copper cables, fiber-optic cables, or the like, between a seafloor detection device and a buoy. The communicative coupling can include wireless communication such as RF-based communication and/or acoustic modems that can transmit data via sound waves to nearby surface buoys, ships, or other underwater devices.

The environment 100 can include ship 120. Ship 120 can contain one or more computing devices, such as a data server, virtualized computing environment, and/or other computing devices for enabling and/or supporting the multimodal orchestration system of disclosed embodiments. Additionally, ship 120 can provide long range communication to one or more remote servers, via the Internet. In one or more embodiments, ship 120 may be equipped with satellite communication (SATCOM). In embodiments, the ship 120 can be equipped with a satellite antenna. The satellite antenna can enable a connection with a geostationary satellite and/or a low-Earth-orbit (LEO) satellite, that in turn relays data to a ground station connected to the internet. The ship 120 may further be equipped with a cellular transceiver to utilize a cellular network when within the range of coastal areas.

Within the body of water 102, a wide variety of aquatic life may be present. The aquatic life can include one or more dolphins/porpoises, indicated at 110 and 112. These can include the Bottlenose Dolphin (Tursiops truncatus), Common Dolphin (Delphinus delphis), Dusky Dolphin (Lagenorhynchus obscurus), Harbor Porpoise (Phocoena phocoena), Spectacled Porpoise (Phocoena dioptrica), Orca or Killer Whale (Orcinus orca), and/or other varieties of dolphin/porpoise. These intelligent and diverse marine mammals contribute significantly to marine ecosystems and hold a special place in human culture and scientific research. Each species has its unique adaptations to its habitat, from the open ocean to coastal regions and even rivers. In embodiments, communication between the dolphins/porpoises for the multimodal orchestration system of disclosed embodiments may be accomplished by sending acoustic signals to the dolphins/porpoises and/or receiving acoustic signals from the dolphins/porpoises via buoys (122, 124) and/or seafloor detection devices (132, 134).

The aquatic life within body of water 102 can include one or more octopus/squid, indicated at 114. The octopus can include a Common Octopus (Octopus vulgaris), Giant Pacific Octopus (Enteroctopus dofleini), Mimic Octopus (Thaumoctopus mimicus), and/or other types of octopus. The squids can include a Giant Squid (Architeuthis dux), Colossal Squid (Mesonychoteuthis Hamiltoni), Common Squid (Loligo vulgaris), and/or other types of squids. Both octopuses and squids are among the most intelligent invertebrates, exhibiting behaviors that suggest advanced cognitive abilities, such as learning, problem-solving, and communication. In particular, octopuses have been known for their ability to solve complex puzzles, such as opening jars, navigating mazes, and manipulating objects in creative ways. Octopuses like the common octopus (Octopus vulgaris) have demonstrated learning through observation and trial-and-error. Additionally, some squids can learn to avoid predators by associating specific cues (like the presence of certain predators) with danger. These traits and abilities can be used for enabling multimodal orchestration for human-animal-robot collaborative task execution.

The aquatic life within body of water 102 can include one or more whales, indicated generally at 108. The whales can include Baleen whales (Mysticeti) and/or toothed whales (Odontoceti). The Baleen whales can include the Blue Whale (Balaenoptera musculus), Humpback Whale (Megaptera novaeangliae), Fin Whale (Balaenoptera physalus), Minke Whale (Balaenoptera acutorostrata), and/or other varieties of Baleen whale. The toothed whales can include a Sperm Whale (Physeter macrocephalus), Beluga Whale (Delphinapterus leucas), Narwhal (Monodon monoceros), and/or other types of toothed whale.

The environment 100 may include one or more marine life wearable electronic devices, such as indicated at 138, affixed to whale 108. The marine life wearable electronic device 138 can include one or more sensors, such as a GPS receiver. The GPS receiver may obtain geolocation data for the whale 108 at times when the whale surfaces. The marine life wearable electronic device 138 may further include one or more acoustic positioning sensors for using triangulation with other devices, such as buoys (122, 124) and/or seafloor detection devices (132, 134) to determine a relative position. The marine life wearable electronic device 138 may further include an accelerometer and gyroscope for tracking movement data, including swimming behavior, diving depth, and/or orientation.

Since whales may communicate via sound, and some whales use echolocation to navigate and find prey, the marine life wearable device 138 may include sensors to detect these sounds or transmit sounds to communicate with the whale 108. The sensors can include a hydrophone to detect vocalizations from the whale (such as songs, calls, or clicks) and record ambient underwater sounds. The marine life wearable device 138 may further include a transducer configured and disposed to emit sounds or vocalizations that can be heard by the whale, facilitating communication and/or behavioral studies. In embodiments, the transducer is tuned to output sounds in frequencies that whales can hear and interact with. In one or more embodiments, the marine life wearable device 138 may further include a haptic module. The haptic module can enable the marine life wearable device 138 to provide tactile feedback to the whale. The haptic vibrations can be delivered through components such as a waterproof vibration device that creates a physical sensation, in order to provide feedback to the whale.

The acoustic communication with whale 108 can include complex vocalizations and communication methods. These sounds can serve various purposes, including navigation, identification, mating, and social interactions. The types of sounds whales produce and the patterns they follow depend on the species, as different whales communicate in different ways. The sounds can include ‘songs.’ These songs are complex, long sequences of sounds that often repeat in patterns and can last for several minutes to hours. Male humpback whales are especially known for their songs, which may be used for mating purposes. The songs consist of different “themes” that are repeated in a specific order and may change over time. The songs can carry for miles underwater, allowing males to attract females or compete with other males.

The sounds can include clicks. The clicks can be short, sharp sounds that are used primarily for echolocation (a form of biological sonar). By emitting clicks and analyzing the returning echoes, whales can navigate and detect prey. In some species, clicks are used for communication, especially in social species like orcas and dolphins, where they may serve to coordinate group behavior or signal social intentions. The sounds can include low-frequency sounds. The low-frequency sounds vary from low-frequency moans and grunts to more intense roars, which are thought to be used for communication over long distances. The sounds are often very deep and can travel hundreds of miles across the ocean. The sounds can include non-vocal sounds, such as tail slaps. Some whales, such as humpback whales, may use physical slaps of their tails (flukes) or pectoral fins to produce sounds that may be used for communication, signaling aggression, or coordinating with others in their group. In one or more embodiments, the sound patterns, and corresponding animal behaviors may be stored in a database or other suitable format to serve as training data for one or more machine learning systems to facilitate interspecies communication between humans and/or one or more non-human animal species.

The marine life wearable device 138 further includes a power source, such as a rechargeable or replaceable battery. In some embodiments, the marine life wearable device 138 may be a disposable device with a one-time use sealed battery, such as a lithium-ion battery. In one or more embodiments, the marine life wearable device 138 may be affixed via a strap to the tail fin, or other appendage of the whale. In embodiments, the strap can be comprised of a biodegradable material that dissolves or decomposes over time, enabling the marine life wearable device 138 to fall off the whale after a period of time, such that the device does not cause any permanent discomfort for the whale. In some embodiments, the marine life wearable device 138 may be affixed via a biodegradable adhesive. The biodegradable adhesive can include a starch-based adhesive, and can be formulated to wear off after a period of time, enabling the marine life wearable device 138 to fall off the whale, such that the device does not cause any permanent discomfort for the whale.

The environment 100 may further include an autonomous underwater vehicle 140. The autonomous underwater vehicle 140 can be an electromechanical device that includes an onboard computer for receiving commands and/or data from ship 120, buoys (122, 124), marine life wearable device 138, and/or seafloor detection devices (132, 134). Embodiments can include receiving additional human communication data, and outputting the additional human communication data to one or more electromechanical devices, such as autonomous underwater vehicle 140. Embodiments can include receiving additional human communication data, and outputting the additional human communication data to one or more electronic devices, such as a remote computing device located on ship 120.

The types of tasks performed by the multimodal orchestration for human-animal-robot collaborative task execution can include search and rescue, exploration, surveillance, and/or other suitable tasks. Environment 100 can include a shipwreck 145. As an example, to determine the precise location of the shipwreck, size of the debris field of the shipwreck, and/or other information, a collaborative task involving humans (e.g., on ship 120), robots (e.g., autonomous underwater vehicle 140), and non-human animals (e.g., whale 108, octopus 114, and/or dolphins 110, 112) can be executed by using AI-enabled interspecies communication techniques, along with Simultaneous Localization and Mapping (SLAM) techniques enabled by sensors, satellite receivers, radar, lidar, RF-based triangulation, and/or other suitable techniques, as will be further described in the description for the figures that follow.

In one exemplary embodiment, the SLAM subsystem is radically enhanced through the integration of a hybrid, multi-modal sensor fusion architecture that unifies deep-learning-based feature extraction with advanced geometric optimization and uncertainty-aware data association techniques. Building upon the core ideas of AirSLAM and SP-SLAM, the system employs a unified point-line network (PLNet) that concurrently detects both keypoints and structural line features under varying illumination conditions, thereby ensuring robust performance even in the presence of dramatic lighting changes. This deep network is augmented with a tri-plane encoding strategy that efficiently captures scene appearance data while preserving geometric fidelity, enabling dense 3D mapping with minimal memory overhead. The extracted features are then fused with inertial and other sensor inputs via lightweight matching algorithms—such as those inspired by LightGlue—to enable real-time visual-inertial odometry, which continuously refines camera pose estimates without relying on traditional keyframe selection.

Simultaneously, the system leverages a plane-based optimization framework reminiscent of the Eigen-Factors approach, where raw 3D point cloud data from LiDAR or RGB-D sensors is aggregated into a compact summation matrix that captures point-to-plane residuals at linear complexity. By decoupling plane estimation from trajectory optimization through a bilevel formulation, the SLAM subsystem achieves rapid convergence and enhanced accuracy even in complex, cluttered environments. Moreover, the incorporation of Bayesian inference techniques—integrating Random Finite Set (RFS) theory—allows the system to model feature uncertainty probabilistically, thereby eliminating the need for heuristic-based data association. This unified approach ensures that ambiguous or occluded features are handled in a statistically robust manner, significantly reducing localization drift and map inconsistency.

Further advancing these capabilities, the SLAM subsystem integrates uncertainty-aware sensor fusion mechanisms that explicitly model the noise characteristics of diverse sensor modalities. For instance, radar measurements are processed using a polar-coordinate uncertainty model that transforms measurement covariances into Cartesian coordinates, while visual sensors benefit from adaptive weighting schemes based on real-time confidence estimates derived from deep-learning predictions. These uncertainty-aware residuals are incorporated into a weighted least-squares optimization framework that dynamically adjusts the influence of each sensor input according to its reliability, ensuring robust performance even in adverse conditions such as low-light, high-dynamic-range, or noisy sensor environments.

In addition, the SLAM framework is further empowered by a multi-modal integration layer that synchronizes data streams from heterogeneous sources—including visible and infrared cameras, acoustic sensors, underwater LiDAR, and electromagnetic sensors—into a coherent spatial-temporal model. Advanced cross-attention mechanisms are employed to correlate features across modalities, yielding a unified representation that is then used to construct and continuously update a dense, real-time map of the environment. This layer also supports a predictive relocalization strategy, wherein a scene-dependent junction vocabulary and directed acyclic graph (DAG) representation of reasoning steps enable rapid recovery from localization failures. As new data is incorporated, the system dynamically refines both the map and the corresponding agent poses, ensuring seamless adaptation to changes in the operational environment.

Collectively, these enhancements—encompassing adaptive deep feature extraction, plane-based bilevel optimization, uncertainty-aware fusion, and multi-modal data integration—yield a SLAM subsystem that not only overcomes the limitations of conventional approaches but also surpasses state-of-the-art systems in terms of accuracy, robustness, and computational efficiency. By integrating these advanced techniques into the multispecies orchestration framework, the invention achieves unprecedented situational awareness and real-time mapping performance, thereby enabling robust, scalable, and resilient coordinated task execution across diverse domains such as terrestrial, maritime, aerial, and space environments.

In one exemplary embodiment, the SLAM subsystem is radically reengineered to integrate a hybrid, multi-modal data fusion pipeline that not only overcomes the limitations of current visual SLAM systems in dynamic environments but also exceeds the capabilities of DVDS and advanced LiDAR–visual–inertial semantic mapping approaches. In this embodiment, the system first deploys a dual-phase dynamic object exclusion mechanism that simultaneously processes visual and LiDAR inputs using a multi-task deep neural network framework. This framework leverages state-of-the-art image classification, object detection, and semantic segmentation algorithms to filter out transient, moving objects from static scene elements prior to feature extraction. By doing so, the system isolates reliable features even in environments with heavy occlusions, low-texture regions, or rapidly changing illumination, thereby preventing dynamic interference from corrupting downstream optical flow estimation and point cloud registration.

Once dynamic objects are removed, the filtered data is fed into an enhanced transformer-based feature aggregation module—termed the Dispersive Transformer (DisFormer)—which builds on the concept of Top-K Sparse Attention (TKSA) and Mixed-Scale Feed-Forward Networks (MSFN). DisFormer is designed to extract robust, high-dimensional feature representations from both dense visual frames and sparse LiDAR scans by selectively focusing on the most informative signal components while discarding redundant information. This novel transformer module is seamlessly integrated with a gated recurrent unit (GRU) that iteratively refines pose estimates through dense bundle adjustment, effectively combining temporal information with deep semantic cues to continuously update camera and sensor trajectories in real time.

Further distinguishing this embodiment, an object-level semantic mapping layer is incorporated to handle complex, natural environments such as forests, urban scenes, and industrial settings where GNSS signals are unreliable. This layer employs innovative cluster-block data structures that perform object-level segmentation and tracking; for example, in forested environments, individual tree trunks are segmented from LiDAR point clouds and associated with semantic labels obtained from corresponding visual data. These object-level features are then incorporated into a global optimization framework that minimizes mapping drift by enforcing consistency constraints across multiple frames and sensor modalities. This robust semantic mapping capability not only enhances localization accuracy but also provides rich contextual information that can be used for subsequent interspecies coordination and task execution.

To ensure the system operates in real time on embedded platforms, advanced uncertainty-aware sensor fusion techniques are deployed. Each sensor input—whether visual, LiDAR, inertial, or radar—is assigned a dynamically computed confidence score based on its noise characteristics and environmental conditions. These confidence metrics modulate the weighting of individual sensor contributions within a weighted least-squares optimization framework, thereby enhancing robustness to sensor noise, illumination changes, and partial occlusions. By leveraging GPU-based acceleration and efficient inference engines, the entire SLAM pipeline is optimized for low latency, enabling continuous, real-time mapping and localization even under challenging dynamic conditions.

Collectively, these innovations yield a SLAM subsystem that not only filters dynamic elements and robustly extracts discriminative features using novel transformer-based methods but also integrates object-level semantic understanding and uncertainty-aware sensor fusion into a unified, adaptive mapping framework. This comprehensive approach significantly reduces pose estimation errors and mapping drift, while also providing the high-fidelity, context-rich spatial data necessary for coordinated task execution across heterogeneous domains—including terrestrial, maritime, aerial, and even space environments—thereby setting a new benchmark for real-world SLAM performance.

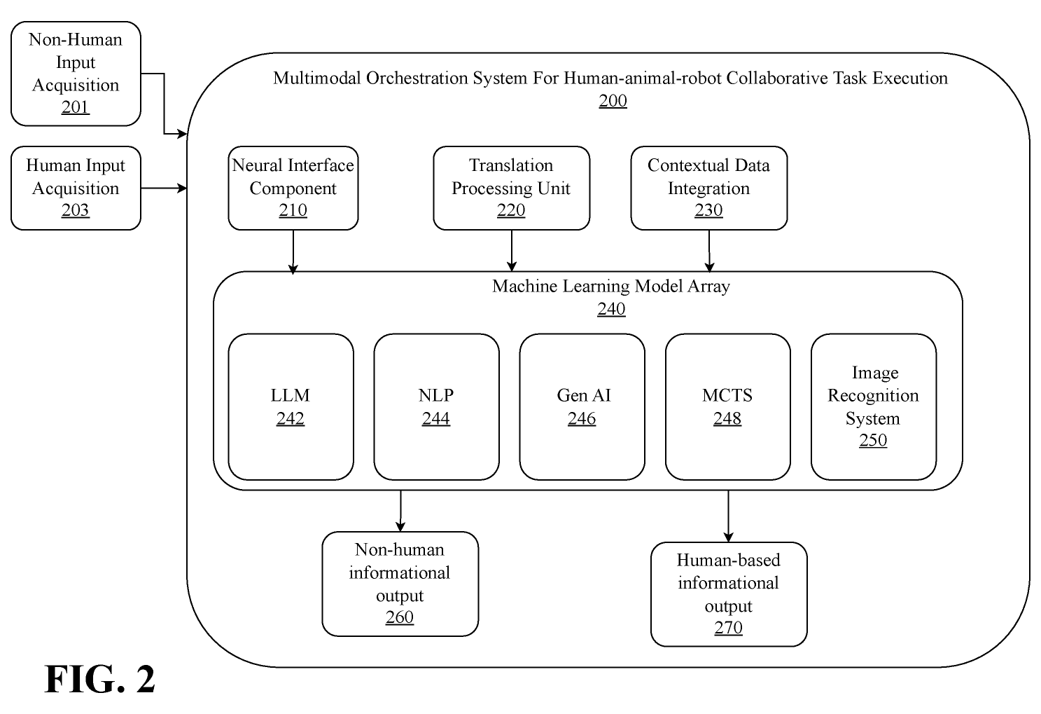

FIG. 2 is a block diagram illustrating components of a system for multimodal orchestration for human-animal-robot collaborative task execution, in accordance with one or more embodiments. System 200 can receive as input, non-human input acquisition 201, and human input acquisition 203. The non-human input acquisition 201 can include input from animals. The input can include audio input. The audio input can include vocalizations such as songs, clicks, chirps, groans, roars, and the like. The audio input can include phonemes and/or words, such as from certain species of birds that are capable of mimicking and producing phonemes from human languages. The audio input can include non-vocal sounds such as tapping or banging sounds from tapping limbs, appendages, or the like. The non-human input acquisition 201 can further include visual information such as sign language gestures, such as may be performed by various primates. The human input acquisition 203 can include spoken language, text input, sign language, and/or other suitable input. The non-human input acquisition 201 and human input acquisition 203 are input to the system for multimodal orchestration for human-animal-robot collaborative task execution 200, and the resulting output can include a non-human informational output 260, and a human-based informational output 270, thereby facilitating interspecies communication.

The system 200 can include a neural interface component 210. The neural interface component 210 can enable the detection of nuanced neural responses from animals that indicate social, emotional, and environmental interactions. The animals can include land animals, such as horses, cats, and dogs. The animals can include aquatic animals, such as whales, dolphins, fish, octopus, and squid. The animals can include birds and other flying animals. In embodiments, the neural interface component 210 may be coupled to the animals to obtain signals indicative of emotional states, and/or other communication patterns. The system 200 can include a translation processing unit 220. The translation processing unit 220 can utilize machine learning models which are trained to correlate neural patterns of animals to known behaviors, vocalizations, and intentions. The system 200 can include a contextual data integration module 230. The contextual integration module 230 can combine modalities (such as neural signals, vocalizations, gestural data, and/or scent vectors) in a multimodal fusion layer. A sliding time window provides temporal alignment, associating changes in scent concentration with concurrent neural or behavioral shifts. The outputs of the neural interface component 210, translation processing unit 220, and/or contextual data integration model 230 are input to machine learning model array 240.

The system may include phylogenic trees, pangenome graphs, or other methods to incorporate evaluation of genomic or multiomics data whenever available. Below is an exemplary embodiment that builds upon and surpasses prior ideas by integrating multiomics and phylogenomic data into the communication orchestration system. In this embodiment, an optimal multiomics and Phylogenomic Communication Orchestration Module (OMPCOM) is introduced. This module is designed to ingest not only the heterogeneous environmental and behavioral sensor data described previously (e.g., acoustic, olfactory, visual, and haptic signals) but also genomic and multiomics information that can be derived from available databases, field-deployed genomic sensors, or even prior ex vivo sequencing of target species. By leveraging advanced data structures such as pangenome graphs and indexing methods like the Graph Burrows-Wheeler Transform (GBWT), the system can rapidly match haplotype segments and evaluate genetic markers that correlate with sensory modalities and communication preferences. In practice, OMPCOM first receives raw multiomics data—ranging from whole-genome sequencing reads to transcriptomic and proteomic profiles—from target animals or representative samples thereof. A dedicated Genomic Data Integration Engine (GDIE) constructs pangenome graphs that capture the full spectrum of genomic variation for the species under consideration. Using GBWT-based algorithms, the system performs efficient haplotype matching to identify key genetic variations, such as allelic variants of olfactory receptor families, auditory sensitivity genes (for example, genes modulating low-frequency hearing thresholds), or vision-related opsin proteins. In parallel, the system builds phylogenetic trees from these haplotype datasets to infer evolutionary relationships and kinship, which can serve as proxies for shared sensory preferences or communication behaviors among individuals and subspecies. By establishing these genomic “communication profiles,” the system can predict the modalities that are likely to be most effective for each target animal or group. Once the genomic profiles are established, OMPCOM fuses this data with real-time environmental and behavioral sensor inputs using a neurosymbolic fusion engine. For instance, if the genomic data reveal that a particular subpopulation of whales possesses genetic markers indicative of heightened low-frequency hearing sensitivity and an evolved propensity for acoustic crypsis (as demonstrated in flight species that call below 80 Hz), then the system will favor the use of low-intensity, low-frequency acoustic signals when communicating with those individuals. Conversely, if genomic markers suggest that certain terrestrial animals, such as domesticated cattle or elephants, have a predisposition for robust olfactory reception due to expansive receptor gene families, the system may select calibrated scent emissions as the primary communication channel in environments where auditory cues are compromised by urban noise. The decision algorithm employs reinforcement learning techniques in a multi-armed bandit framework to weigh the expected utility of each communication modality—considering factors such as environmental noise, predation risk, and even the potential for inadvertent aggregation of non-target species—and updates its modality-selection policy dynamically as additional multiomics and contextual data become available. Furthermore, OMPCOM may be operated in an open, partially open or within a closed-loop feedback system. After a communication event, behavioral responses (e.g., changes in movement patterns, physiological responses measured via wearable biosensors, or even genomic stress markers captured through rapid point-of-care assays) are analyzed to refine both the genomic profiles and the modality selection policy. This iterative process is supported by adaptive caching of frequently observed genomic subgraphs and phylogenetic motifs, which are stored using run-length–compressed indices (e.g., via GBWT) to ensure near-linear space complexity even when operating at biobank scale. The integration of these genomic data structures not only enhances the precision of interspecies communication but also enables the system to adjust for evolutionary pressures—for example, by detecting shifts in haplotype frequencies that may correlate with changes in communication efficacy due to environmental stressors like noise pollution or habitat fragmentation. By combining environmental sensor fusion, real-time SLAM-derived context, and the cutting-edge processing of multiomics data through pangenome graphs and phylogenetic analyses, this embodiment achieves a truly interdisciplinary approach. It leverages computational genomics methods to inform and optimize multispecies communication strategies, thereby surpassing traditional modality selection systems. This innovative integration enables the orchestration system to adaptively choose between acoustic, olfactory, visual, and haptic outputs with unprecedented precision, ensuring that messages are delivered in a form that maximizes reception by the intended species while minimizing unintended interactions—whether in a busy urban environment, a predator-dense ocean, or a field setting where evolutionary histories dictate distinct sensory preferences.

Machine learning model array 240 may include one or more machine learning models, neural networks, and/or other systems for processing and interpreting input data. The machine learning model array 240 can include a large language model 242. The large language model (LLM) 242 can be trained for specific animals (e.g., species-specific or even individual-specific) and can ingest continuous streams of neural population data recorded across multiple tasks and states. These models go beyond simple language: they become multimodal encoders of animal neural signals, motor outputs, observed behaviors, and contextual cues. By structuring training data to include “high-incentive” versus “neutral” tasks, the LLM can learn when the animal’s neural signature deviates from its optimal preparatory patterns. In embodiments, the machine-learning system includes a large language model (LLM).

The machine learning model array 240 can include a natural language processing (NLP) module 244. The NLP module 244 can enable the conversion of human speech to animal-understandable patterns. The NLP module 244 can include NLP pipelines that parse human language into semantic tokens. These tokens can then be mapped onto a species-specific “neural command embedding space.” For whales, this might involve converting a request such as ‘swim to the surface’ into a neural stimulation pattern, along with an auditory output pattern such as a song or pattern of clicks. For canines, this might involve converting a request like “Fetch the red ball” into a neural stimulation pattern plus a subtle auditory or tactile cue that aligns with the dog’s pre-trained internal representations of the action “fetch” and the visual concept “red ball.”

The machine learning model array 240 can include a generative artificial intelligence (Gen AI) module 246. The Gen AI module 246 can enable supplementing training data with synthesized data, such as vocal data (e.g., canine vocalizations or whale codas), where the vocal data is created with properties such as number and regularity of signal units (clicks, barks), spectral means, and/or amplitude envelopes. The Gen AI module 246 can include a generative adversarial network (GAN), such as WaveGAN, InfoGAN, fiwGAN, and/or other suitable GAN.

The machine learning model array 240 can include a Monte Carlo Tree Search (MCTS) module 248. The MCTS module 248 can enable adaptive, look-ahead scheduling decisions. Instead of applying fixed heuristics or static load-balancing, disclosed embodiments can simulate and/or evaluate multiple future states of the pipeline before choosing the next action. By repeatedly exploring and exploiting different pipeline routing decisions (e.g., which specialist model to send partial outputs to, or how to scale certain pipeline segments), MCTS can minimize the cumulative regret over time, converging toward near-optimal scheduling policies that are robust to changing conditions, input distributions, and latency constraints. In one or more embodiments, the MCTS module 248 can enable enhanced resource allocation, such as allocating more GPUs, selecting specialized hardware accelerators, and/or adjusting batch sizes downstream.

The machine learning model array 240 can include an image recognition system 250. Image recognition system 250 may utilize machine learning to identify objects and gestures in images and video clips. The training can include obtaining a large dataset of labeled images or video clips that include the objects and/or gestures that are to be identified. Using techniques such as convolutional neural networks (CNNs), relevant features from the images are automatically extracted. A machine learning model (e.g., a deep learning model) is trained on the extracted features. Once trained, the model can be used to predict the presence of objects or gestures in new, unseen images and/or video clips. The images and/or video clips can include images of non-human animals exhibiting facial expressions, performing gestures, and/or other interpretable behaviors. Image recognition system 250 may further utilize Haar cascades for object detection. One or more embodiments can include training the Haar cascade classifier using a combination of positive samples and negative samples. The training process can include selecting the most relevant features and creating a cascade of classifiers.

The machine learning model array 240 can include, as an output, non-human informational output 260. The non-human informational output 260 can include audio output. The audio output can include species-specific audio waveforms such as clicks and songs for cetaceans, growling and/or barking sounds for canines, and so on. In an aquatic environment such as depicted in FIG. 1, the audio output may be provided by underwater speakers or other suitable transducers. The non-human informational output can include visual output, such as flashing lights, and/or patterns rendered and presented on an electronic display that is visible to the animals that are participating in the system and/or method for multimodal orchestration for human-animal-robot collaborative task execution.

The machine learning model array 240 can include, as an output, human-based informational output 270. The human-based informational output 270 can include visual information such as text and/or symbology. The human-based informational output 270 can include audio information. The audio information can include synthesized speech, tones, and/or other sounds to convey information identified by the machine learning model array 240. Referring again to the example depicted in FIG. 1, for investigation of the shipwreck 145, the non-human informational output 260 can include audio waveforms that may be interpreted by a whale 108 to swim to a location proximal to the shipwreck 145. The whale 108 may then output audio vocalizations in response to viewing the shipwreck. The output audio vocalizations can be translated by the system 200 to human-based informational output 270 for interpretations by humans. In this way, the non-human informational output 260 and the human informational output 270 can work in tandem to enable human-animal-robot collaborative task execution.

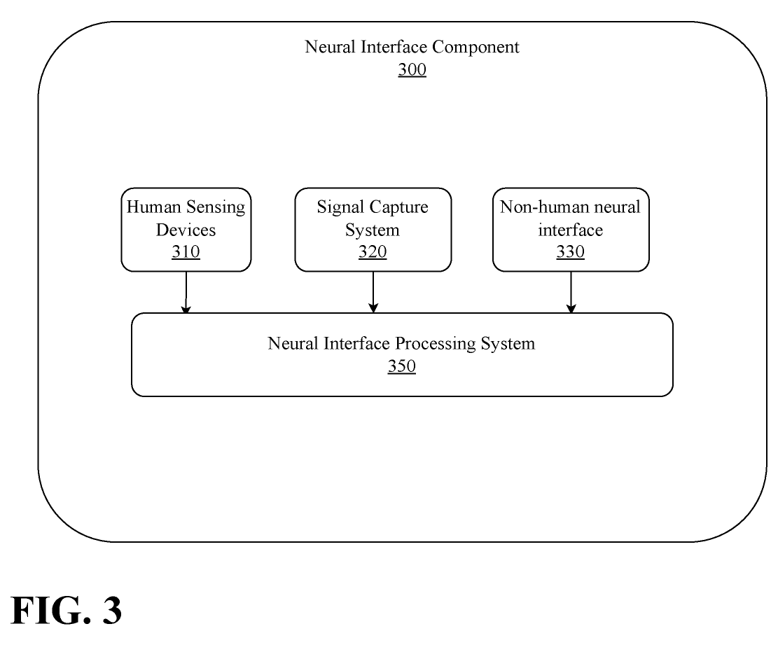

FIG. 3 is a block diagram illustrating details of a neural interface component, in accordance with one or more embodiments. Neural interface component 300 may be similar to neural interface component 210 of FIG. 2, and can include one or more human sensing devices 310. The human sensing devices 310 can include wearable sensors, such as pulse sensors, brainwave monitors, and the like. The human sensing devices 310 can further include cameras, microphones, and/or other sensors for obtaining cognitive state information from a human. The data received by the human sensing devices may be used with NLP module 244 to extract additional context and sentiment from humans participating in human-animal-robot collaborative task execution.

Neural interface component 300 can include a signal capture system 320. The signal capture system 320 can include one or more sensors for capture of neural and physiological signals without distress, adjusted for the physical characteristics of animals, such as cetaceans. In embodiments, neural sensors are embedded within wearable and/or attachable devices suited for underwater and open-ocean deployment. In embodiments, the neural interface includes components tailored to the species’ specific anatomy, such as the head or dorsal regions in whales, and made from materials that ensure durability and comfort even in the deep-sea environment. In embodiments, at least one of the first output element and the second output element comprise an underwater transducer.

Neural interface component 300 can include a non-human neural interface 330. The non-human neural interface 330 can include non-invasive sensors that can detect and measure animal brain activity without causing discomfort. These sensors capture neural signals associated with emotions, intentions, and responses to stimuli. The non-human neural interface 330 can further include implanted sensors. Embodiments can include surgically implanting sensor probes inside an animal’s brain. In embodiments, this technique can be used in place of a non-invasive sensor package, and can yield additional control and benefits that include the ability to record specific thoughts, evaluate mental state, and other aspects outside of the direct intent to communicate. This also enables capturing the animal’s sensory data such as vision and scent. This allows human/animals to not only communicate freely, but opens additional options for working animals. For example, a dog must pass extensive training before it can sniff drugs. With disclosed embodiments, the training may be drastically shortened by reading the animal’s brain patterns directly and identifying targeted substances via this data. As part of the training, the non-human informational output 260 (of FIG. 2) may produce a signal to cause happiness or the notion of correctness as a positive reward and drastically speed training times and animal willingness.

The output of the human sensing devices 310, signal capture system 320, and non-human neural interface 330 can be input to neural interface processing system 350. Neural interface processing system 350 can include an AI-based processing unit that analyzes and interprets vocalization data, behavioral cues, and environmental contexts to foster bidirectional communication between humans and non-human animals. Disclosed embodiments can be well-suited for applications ranging from enhancing human-animal interactions for conservation to advancing scientific understanding of animal languages, particularly in highly social and intelligent species such as sperm whales. Furthermore, disclosed embodiments can enable the use of environmental and behavioral metadata integration, as well as robust machine learning frameworks, allowing creation of an adaptable model for studying communication across various species, making disclosed embodiments adaptable to diverse animal communication needs beyond cetaceans, such as canines, primates, and other species.

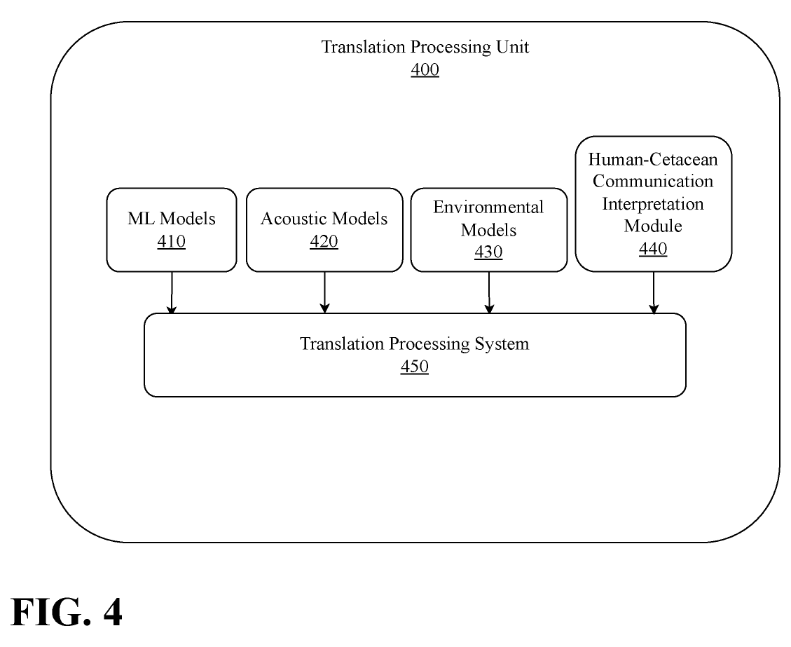

FIG. 4 is a block diagram illustrating details of a translation processing unit, in accordance with one or more embodiments. Translation processing unit 400 may be similar to translation processing unit 220 of FIG. 2, and can include one or more machine learning models 410. In embodiments, the machine learning models 410 can be trained to identify patterns in vocalization, such as codas, tempo, rhythm, ornamentation, and contextual variations like rubato. This training enables disclosed embodiments to decode structured and nuanced elements of cetacean communication, potentially revealing hierarchical or associative structures similar to human language. The translation processing unit 400 can include one or more acoustic models 420. The acoustic models 420 may enable replication of fricative production. This includes adjusting tongue position, airflow velocity, and constriction points. The translation processing unit 400 can further include one or more environmental models 430. The environmental models 430 can include probabilistic models to capture the uncertainty and variability inherent in fricative sound production and perception. The translation processing unit 400 can further include a human-cetacean communication interpretation module 440. In embodiments, the human-cetacean communication interpretation module 440 can enable mappings between humans and cetaceans. As an example, the clicks, songs, and codas of whales can be processed via machine learning, and mapped to human sentiments, such as danger, affection, joy, aggression, curiosity, and/or cooperation. In embodiments, the human sentiment can be derived from animal outputs, such as sounds made by animals, gestures made by animals, facial expressions made by animals, and so on. The danger may be represented by high-pitched whistles, rapid clicks, and/or abrupt calls. Affection may be represented by soft clicks, whistles, and/or low-pitched moans. Joy may be represented by rapid clicks, whistles, and/or varied, upbeat vocalizations. Aggression may be represented by loud, forceful vocalizations, grunts, or low-frequency rumbles. Curiosity may be represented by short bursts of clicks. Cooperation may be represented by repetitive clicking patterns. In general, cetacean sounds may be catalogued and correlated to a behavioral context.

The translation processing system 450 receives input from the ML models 410, acoustic models 420, environmental models 430, and human-cetacean communication interpretation module 440. The translation processing system 450 can be configured to convert animal neural patterns into human-comprehensible language, conveying the emotional state, intentions, and/or needs of the animal. The translation processing system 450 can further be configured to translate human speech into neural signals or cues that are meaningful and understandable to animals, allowing the animals to comprehend specific commands or sentiments directly. In embodiments, the translation processing system 450 may be configured to produce spoken translations of animal communications, thereby allowing humans to understand an animal’s emotions or needs. For instance, the system might translate a dog’s neural signals into phrases like “I am hungry” or “I’m feeling anxious.”

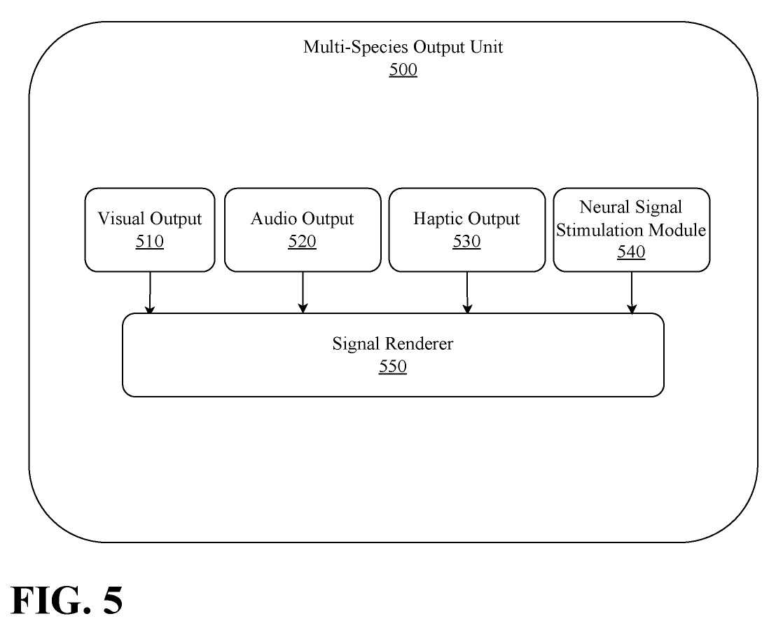

FIG. 5 is a block diagram illustrating details of a multi-species output unit 500, in accordance with one or more embodiments. The multi-species output unit is an innovative computerized system designed to facilitate communication between humans and animals by integrating multiple sensory modalities for output. The visual output subsystem 510 processes and assembles video and image data for output on an electronic display. The visual output is tailored to the perceptual capabilities of the target species, ensuring that animals or humans can interpret the visual signals effectively. The audio output subsystem 520 can be configured to generate audio waveforms that can be output through speakers or other audio devices. The audio output can include species-specific sounds, such as vocalizations, frequencies, or tones, enabling communication in a form recognizable by the intended animal. The haptic output subsystem 530 generates and modulates signals to drive vibratory devices, creating tactile sensations that can be detected via wearable sensors or directly on the animal’s skin. The haptic feedback can convey information such as alerts, directions, or emotional cues. The neural signal stimulation module 540 can include electrodes capable of monitoring and interacting with brainwaves of an animal. It can record neural activity and deliver carefully modulated stimulation to influence or reinforce specific neural patterns. This capability offers potential for advanced applications, such as training, behavior modification, or facilitating direct neural communication. The signal renderer module 550 serves as the central decision-making unit, determining the most appropriate output device for each signal. It integrates the outputs from the visual, audio, haptic, and neural modules and ensures that the signals are delivered in a coherent and species-appropriate manner. In embodiments, the multi-species output unit 500 may be integrated into, or communicatively coupled with, non-human informational output 260 and/or human-based informational output 270.

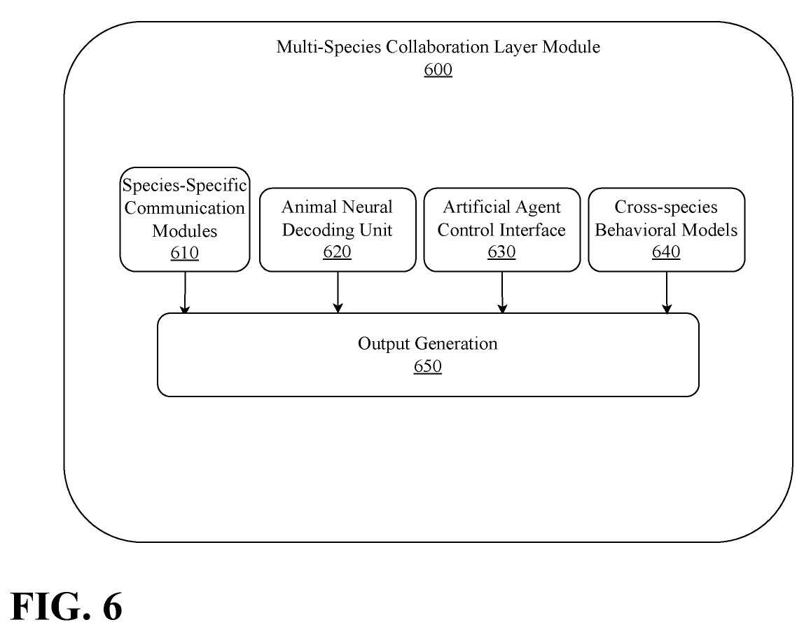

FIG. 6 is a block diagram illustrating details of a multi-species collaboration layer module 600, in accordance with one or more embodiments. The Multispecies Collaboration Layer (MCL) builds on the foundational capabilities of neural interfaces, multimodal sensory processing, and language modeling techniques, extending them to facilitate purposeful, synchronized interaction across species or between animals and machines. Its key functions are to understand interspecies “vocabularies,” align goals, and orchestrate collaborative tasks. The MCL module 600 can include one or more species-specific communication modules 610. In embodiments, each participating species (e.g., dogs, elephants) or artificial agent (e.g., a drone) has its own communication interface and representation layer.

The MCL module 600 can further include an animal neural decoding unit 620. The animal neural decoding unit 620 can be configured to extract interpretable “meaning vectors” from the animal’s neural signals and observed behavior. As an example, for a dog, neural patterns plus posture/vocalization cues can produce a “conceptual state embedding” representing intentions and emotional states. The MCL module 600 can further include an artificial agent control interface 630. For a drone, sensor data (LIDAR, camera, GPS) and command frameworks are translated by the artificial agent control interface into abstract action representations (e.g., “search pattern initiated,” “altitude adjustment needed”). The MCL can further include one or more cross-species behavioral models 640. These models can utilize a library of known behavioral cues and tasks common to various species (e.g., “move towards scent,” “alert upon detection of target”) to produce standardized action and intention descriptors.

The MCL module 600 further includes an output generation module 650 that receives input from the species-specific communication modules 610, animal neural decoding unit 620, artificial agent control interface 630, and/or cross-species behavioral models 640. The output generation module 650 then generates an appropriate output signal, which can include a video signal, audio signal, haptic signal, and/or other bioelectrical signal for conveying sentiment and/or meaning among humans and non-human animals. The output generation module 650 can output data in a wide variety of digital and/or analog formats, including pulse code modulated (PCM) audio, raw video formats, compressed video formats, and/or other suitable formats.

In embodiments, the Multispecies Collaboration Layer can be configured to provide a unified, context-driven platform enabling animals of different species, as well as robots and/or drones, to collaborate effectively on shared tasks. By creating and refining interspecies dictionaries, using ML models to align intentions, and carefully timing and routing these concepts through a shared task representation space, the MCL module 600 can enable synchronized, purposeful action. This can profoundly enhance capabilities in wildlife conservation, service support, and environments where diverse species and agents work in concert to achieve common goals. In embodiments, the MCL module 600 can be integrated with, or communicatively coupled to, system 200 of FIG. 2.

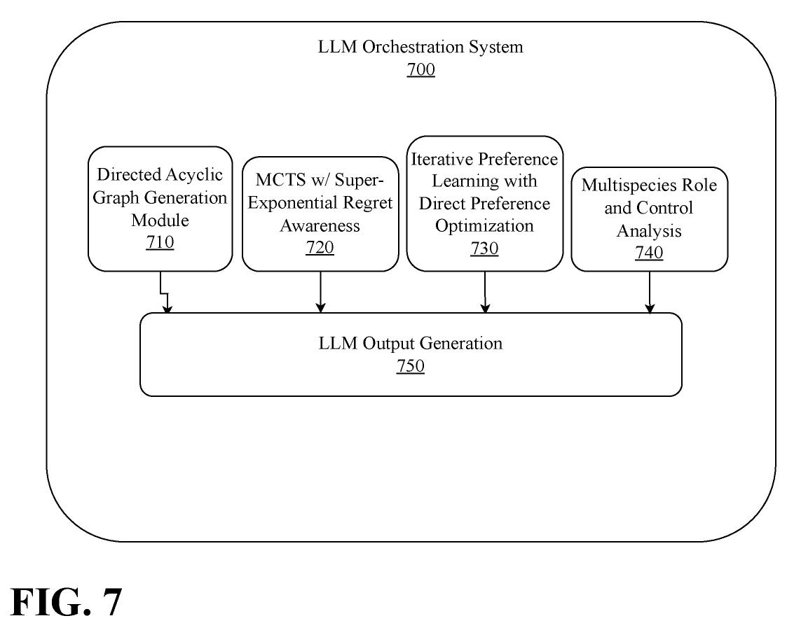

FIG. 7 is a block diagram illustrating details of a large language model (LLM) orchestration system 700, in accordance with one or more embodiments. In embodiments, LLM orchestration system 700 may be integrated with, or communicatively coupled to, LLM 242 of FIG. 2. LLM orchestration system 700 can include directed acyclic graph (DAG) generation module 710. The DAG generation module 710 can create a DAG representing complex workflows in which nodes are reasoning steps, and edges represent transitions from one partial solution to another. In some embodiments, each node encodes the current state of the environment, such as position and behavior of animals, humans’ textual instructions, and/or robot sensor readings. The DAG’s expansions can correspond to MCTS-like searches over possible reasoning paths, guided by previously described methods (e.g., embedding caches, semantic KGs, preference learning). Embodiments can include generating a directed acyclic graph to represent a plurality of reasoning steps corresponding to the multispecies coordinated task execution.

The LLM orchestration system 700 can include MCTS w/ Super Exponential Regret Awareness module 720. In this context, “super-exponential regret” refers to the phenomenon where certain algorithms, specifically the Upper Confidence bounds applied to Trees (UCT) and its variants like AlphaGo’s Monte Carlo Tree Search (MCTS), can experience regret that grows at a super-exponential rate under specific conditions. Regret, in this setting, measures the difference between the actual performance of the algorithm and the optimal performance it could have achieved. This module 720 may adjust model parameters to reduce or minimize regret, thereby improving performance. The adjustments made by module 720 can include modifying exploration-exploitation tradeoffs (e.g., fine-tuning of exploration constants in UCT).

The LLM orchestration system 700 can include iterative preference learning with direct preference optimization module 730. In embodiments, each node’s expansions produce step-level preference data: which partial expansions yield better outcomes (improved translation quality, correct interpretation of animal signals). After collecting these preferences (through MCTS expansions and intermediate verification from debate steps), module 730 can apply Direct Preference Optimization (DPO) to refine the LLM’s underlying policy. Over multiple cycles, on-policy sampled data enable the LLM’s decision-making to improve at picking high-value expansions from the start. This reduces reliance on brute-force exploration and counters the conditions leading to super-exponential regret.

The LLM orchestration system 700 can include multispecies role and control analysis module 740. In embodiments, module 740 can model agents as having different influence roles, which can dynamically encourage certain agents to lead expansions in known-productive directions. Moreover, module 740 can be configured to let other agents anchor or block suspicious expansions (such as an octopus punching unhelpful fish), which are translated into immediate pruning of subgraphs in the reasoning DAG.

The LLM orchestration system 700 can include an LLM output generation module 750 which receives as input, outputs from the directed acyclic graph generation module 710, MCTS with Super Exponential Regret Awareness module 720, include iterative preference learning with direct preference optimization module 730, and/or multispecies role and control analysis module 740. The output from the LLM output generation module 750 can include information for human consumption, such as textual information, knowledge-based outputs, and/or structured data. The output from the LLM output generation module 750 can include information for robot consumption, such as commands, sensor data, and/or other command and control information. The output from the LLM output generation module 750 can include information for animal consumption, such as audio waveforms intended for interpretation by animals, such as tones and/or click patterns for cetaceans, tones and/or sounds for canines, and so on. Other signals for representation in visual and/or haptic domains may also be output by LLM output generation module 750 in some embodiments.

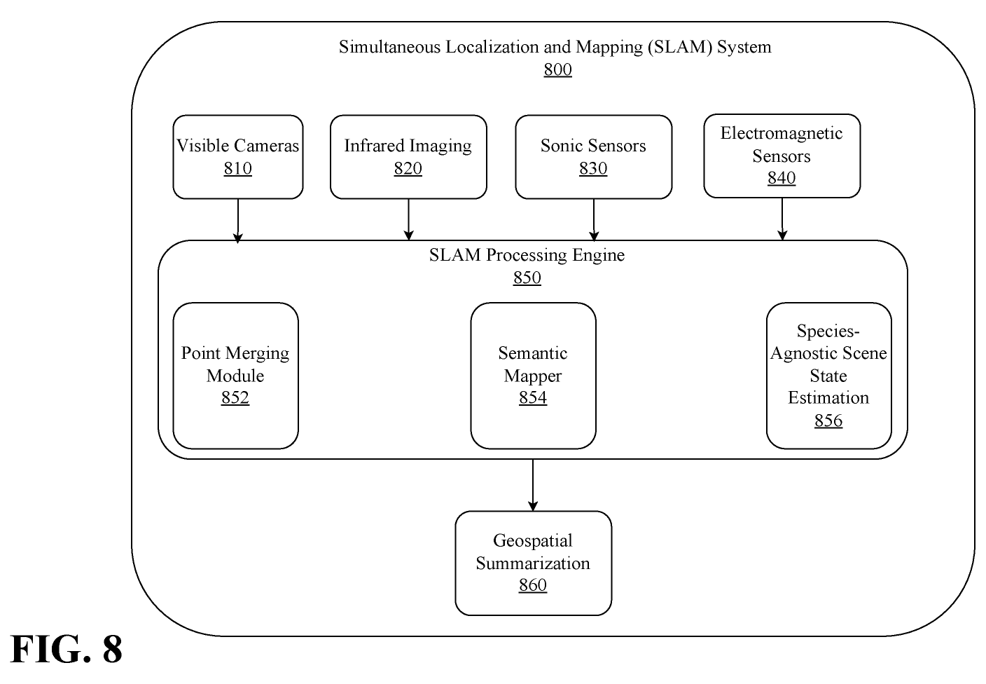

FIG. 8 is a block diagram illustrating details of a Simultaneous Localization and Mapping (SLAM) system 800, in accordance with one or more embodiments. In embodiments, SLAM system 800 may be integrated with, or communicatively coupled to, system for multimodal orchestration for human-animal-robot collaborative task execution 200 of FIG. 2. System 800 can include visible cameras 810, infrared imaging sensors 820, sonic sensors 830, and/or electromagnetic sensors 840. The visible cameras 810 may be configured to detect light in the visible spectrum (roughly 400–700 nanometers), which is the range of light perceptible to the human eye, and capture colors and details as humans see them, relying on external light sources (e.g., sunlight or artificial lighting) to illuminate a scene. The visible cameras can include wide-angle cameras, telephoto cameras, and so on. The infrared imaging sensors 820 can be configured to detect light in the infrared spectrum (beyond 700 nanometers), which is invisible to the human eye. In some embodiments, the infrared imaging sensors 820 can include thermal cameras that can capture emitted heat radiation from objects, even in complete darkness, without requiring external illumination. The sonic sensors 830 can include microphones and/or hydrophones. The microphones can include dynamic microphones, condenser microphones, electret microphones, and/or other suitable types of microphones. The hydrophones can include piezoelectric hydrophones that use piezoelectric materials to detect pressure changes in water caused by sound waves. The hydrophones can include vector sensors that measure both sound pressure and particle motion within water. The hydrophones can include a hydrophone array that includes multiple hydrophones arranged in a specific geometry to detect sound from multiple directions.

The electromagnetic sensors 840 can be configured to detect and measure electromagnetic fields or properties, such as electrical conductivity, magnetic fields, and electromagnetic radiation. The electromagnetic sensors 840 can include fluxgate magnetometers, suitable for detecting magnetic anomalies from seafloor rocks, or identifying metallic objects like shipwrecks or submarines. The electromagnetic sensors 840 can include proton precession magnetometers that can measure the magnetic field based on the precession of protons in water or a fluid. In one or more embodiments, the electromagnetic sensors can include optically pumped magnetometers, electric field detectors, capacitive sensors, electromagnetic induction sensors, and/or other suitable types of electromagnetic sensors.

The inputs from visible cameras 810, infrared imaging sensors 820, sonic sensors 830, and electromagnetic sensors 840 can be input to SLAM processing engine 850. SLAM processing engine 850 can include a point merging module 852. In embodiments, the point merging module 852 can include functions and instructions for combining multiple data points that correspond to the same real-world feature. This helps refine the map, reduce noise, and improve localization accuracy. SLAM processing engine 850 can include a semantic mapper 854. In embodiments, the semantic mapper 854 can include functions and instructions for enabling humans to interpret animal emotional states or intentions through augmented reality interfaces linked to embeddings and semantic mapping. The semantic mapper 854 may further include a Semantic Alignment Agent that can refine cross-domain mappings accordingly. Moreover, SLAM processing engine 850 can further include a species-agnostic scene state estimation module 856. In embodiments, the species-agnostic scene state estimation module 856 can include functions and instructions for utilizing data from visible light cameras to determine color and depth of a scene, enabling a 3D reconstruction of an environment. The species-agnostic scene state estimation module 856 can further include functions and instructions for utilizing data from ultraviolet (UV) and/or hyperspectral sensors, which can provide benefits as some animal signals might be visible only in UV or certain spectral bands, revealing hidden patterns (like UV-reflective markings on fish or subtle changes in an octopus’s skin). The species-agnostic scene state estimation module 856 can further include functions and instructions for utilizing data from lidar scanners that produce high-resolution point clouds for both indoor and outdoor environments. In one or more embodiments, radar can complement lidar in poor visibility conditions. The species-agnostic scene state estimation module 856 can further include functions and instructions for utilizing data from sonic and/or acoustic sensors to capture vocalizations from a wide variety of animals. Embodiments can further utilize beamforming and/or signal processing in order to locate sound sources and/or identify distress calls, barks, or other meaningful vocal patterns in non-human animals.

The output of the SLAM processing engine 850 can include a geospatial summarization 860. The geospatial summarization 860 can include data that can be rendered and presented on an electronic display to show features such as a map panel that indicates animal locations, terrain features, and environmental conditions. One or more embodiments can further include icons representing animals that are updated in real-time, displaying status indicators such as color-coded stress levels, activity patterns, and the like. The data output of geospatial summarization 860 can include data in a variety of raster, vector, and/or other suitable formats.

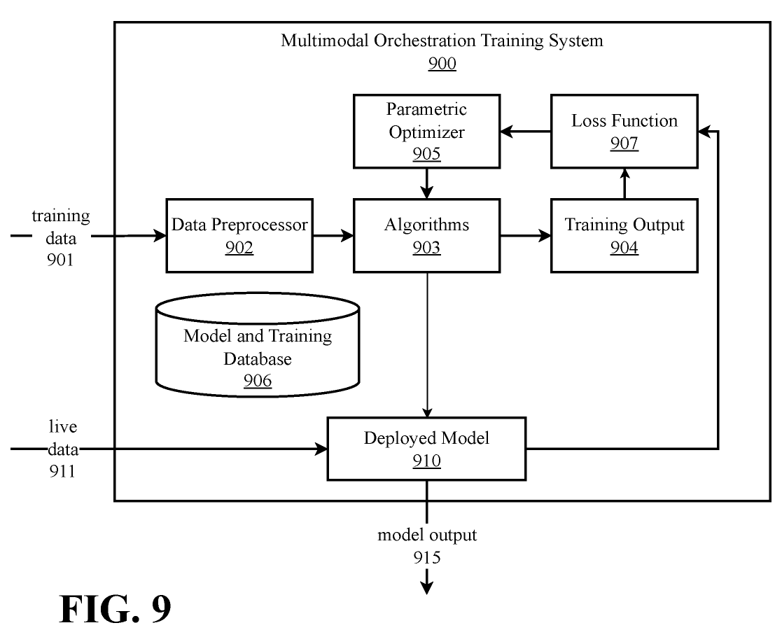

FIG. 9 is a block diagram illustrating an exemplary training system for tasks such as multimodal orchestration for human-animal-robot collaborative task execution and/or integrated multimodal sensor processing for cross-species state estimation, in accordance with one or more embodiments. In embodiments, system 900 may comprise a model training stage comprising a data preprocessor 902, one or more machine and/or deep learning algorithms 903, training output 904, a parametric optimizer 905, and a model deployment stage comprising a deployed and fully trained model 910 configured to perform tasks described herein such as enabling multimodal orchestration for human-animal-robot collaborative task execution. The system 900 may be used to train and deploy a plurality of AI subsystems in order to support the services provided by the system for multimodal orchestration for human-animal-robot collaborative task execution.

At the model training stage, a plurality of training data 901 may be received by the training system 900. Data preprocessor 902 may receive the input data (e.g., human feedback, human input data, animal input data, animal feedback, robot/sensor inputs, and the like) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 902 may also be configured to create a training dataset, a validation dataset, and/or a test set from the plurality of input data 901. For example, a training dataset may comprise 80% of the preprocessed input data, the validation set 10%, and the test dataset may comprise the remaining 10% of the data. The preprocessed training dataset may be fed as input into one or more machine and/or deep learning algorithms 903 to train a predictive model for tasks that can include interspecies communication, geospatial mapping, and/or object monitoring and detection.

During model training, training output 904 is produced and used to measure the accuracy and usefulness of the predictive outputs. During this process a parametric optimizer 905 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLU, Tanh, etc.), the choice of cost or loss function the model will use, number of hidden layers in a neural network, number of activation unites in each layer, the drop-out rate in a neural network, number of iterations (epochs) in training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the training system 900 to evaluate a model’s performance. Metrics can include, but are not limited to, word error rate (WER), word information loss, cetacean response times, predicted animal response compared with actual animal response, and normalization error rate, to name a few. In one embodiment, the system may utilize a loss function 907 to measure the system’s performance. The loss function 907 compares the training outputs with an expected output and determines how the algorithm needs to be changed in order to improve the quality of the model output. During the training stage, all outputs may be passed through the loss function 907 on a continuous loop until the algorithms 903 are in a position where they can effectively be incorporated into a deployed model 915.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 910 in a production environment making predictions based on live input data 911 (e.g., user preferences, user feedback, user inputs). Further, model correlations and restorations made by deployed model can be used as feedback and applied to model training in the training stage, wherein the model is continuously learning over time using both training data and live data and predictions. A model and training database 906 is present and configured to store training/test datasets and developed models. Database 906 may also store previous versions of models.

According to some embodiments, the one or more machine and/or deep learning models may comprise any suitable algorithm known to those with skill in the art including, but not limited to, LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 903 may comprise a deep learning algorithm such as neural networks (e.g., recurrent, convolutional, long short-term memory networks, etc.).

In some implementations, the training system 900 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 906.

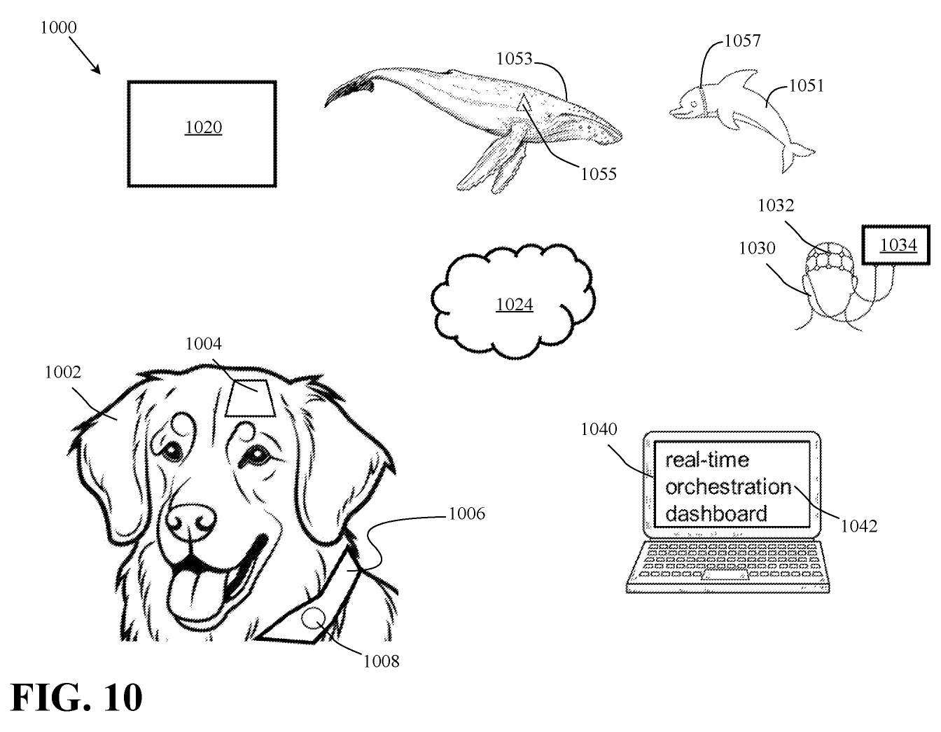

FIG. 10 shows an exemplary environment 1000 in which Monte Carlo tree search-based decision optimization systems for interspecies communication can be used, in accordance with one or more embodiments. Dog 1002 is shown, wearing a non-invasive brainwave sensor 1004. In embodiments, the non-invasive brainwave sensor 1004 may be comprised of a spray-on conductive polymer ink. In embodiments, the conductive polymer ink can include (Poly(3,4-ethylenedioxythiophene):poly(styrenesulfonate)) (PEDOT:PSS). In embodiments, the conductive polymer ink can be applied directly to the scalp or skin using a microjet printing system. In some embodiments, a small area of the dog may be shaved to expose bare skin for applying the conductive polymer ink. The ink can include additives to optimize conductivity, reduce skin impedance, and ensure mechanical durability during prolonged wear. Once applied, the ink dries into a thin, flexible film that conforms seamlessly to the skin surface, even in the presence of hair or irregular contours. In some embodiments, instead of, or in addition to, a spray-on conductive polymer ink, pre-patterned tattoo electrodes can be transferred onto the skin for neural signal acquisition. These electrodes can be composed of biocompatible materials and provide low contact impedance. In some embodiments, the epidermal tattoo sensor can include carbon nanotubes (CNTs), gold nanomaterials, and/or other suitable materials. These sensors can detect brain or muscle activity through electrical signals with high signal-to-noise ratios (SNRs), rivaling traditional invasive systems. In embodiments, the non-invasive brainwave sensor comprises a sensor comprised of conductive polymer ink. In embodiments, the conductive polymer ink comprises (Poly(3,4-ethylenedioxythiophene):poly(styrenesulfonate)) (PEDOT:PSS).

In one or more embodiments, the signals acquired by brainwave sensor 1004 are sent to a non-invasive brainwave sensor auxiliary module 1008 that may be attached to a collar 1006 worn by the dog 1002. In embodiments, the signals acquired by brainwave sensor 1004 can be sent to the brainwave sensor auxiliary module 1008 via near field communication (NFC) techniques, Bluetooth Low Energy (BLE), or other suitable techniques. One or more embodiments may utilize a custom UUID characteristic for EEG data to enable specifying the sample rate, data format, and/or other parameters for transmission of EEG data. The brainwave sensor auxiliary module 1008 can send the acquired signals to a system for AI-enabled interspecies communication 1020, via network 1024. In embodiments, network 1024 can include a cellular network, WiFi network, local area network (LAN), wide area network (WAN), satellite communication network, and/or the Internet. The system for AI-enabled interspecies communication 1020 can include functions and instructions to acquire brainwaves obtained by brainwave sensor 1004. The system for AI-enabled interspecies communication 1020 can further include functions and instructions to perform filtering, data conditioning, and analyzing the brainwaves via machine learning models. The results of the analysis can be sent to a client device 1040 via network 1024. The client device can include a laptop computer, desktop computer, tablet computer, and/or other suitable computing device. The results produced from the system for AI-enabled interspecies communication 1020 can be rendered and presented on electronic display 1042. In embodiments, the results can include a real-time orchestration dashboard. The real-time orchestration dashboard can provide a visual indication of multimodal trends, alerts, and/or recommendation actions, along with geospatial information pertaining to a monitored area.

By integrating multimodal trends, such as vocalizations, movement patterns, and physiological signals, the dashboard can provide a comprehensive overview of behavioral shifts, enabling researchers, conservationists, and caretakers to detect anomalies and respond proactively. Alerts generated by the system can highlight sudden behavioral changes, stress indicators, or unusual activity, allowing timely interventions that improve welfare and management. Additionally, tailored recommendations based on historical data and predictive models can assist in optimizing care routines, habitat management, as well as interspecies interactions.

Beyond individual monitoring, the dashboard’s geospatial capabilities enable users to track environmental correlations with animal behavior, offering insights into migration patterns, habitat preferences, and ecological stressors. In wildlife research, this functionality can identify disruptions caused by climate change, human activity, or territorial disputes. In captive settings, spatial analytics help refine enclosure designs and social group dynamics by mapping movement trends. By visualizing real-time data through an intuitive interface, disclosed embodiments can enhance decision-making, foster a deeper understanding of animal needs, and empower researchers to develop more effective conservation and management strategies.

The environment 1000 can further include a human 1030. The human 1030 can wear a sensor array 1032 to obtain brainwaves from the human. The brainwaves can include signals such as EEG (Electroencephalography), EMG (Electromyography), and/or specific sensory patterns for communication or training purposes. The brainwaves can include different types of brainwaves (e.g., alpha, beta, delta, and/or theta waves) that can be used to analyze cognitive states. The brainwaves can be acquired and stored by data acquisition module 1034. Data acquisition module 1034 can send the brainwave data to the system for AI-enabled interspecies communication 1020 via network 1024. This can enable interspecies communication via brainwaves. As an example, the human 1030 may, via thoughts, generate brainwaves that are detected by sensor array 1032, and acquired by data acquisition module 1034. The data acquisition module 1034 can then send the acquired brainwave data to the system for AI-enabled interspecies communication 1020 via network 1024, where the system for AI-enabled interspecies communication 1020 analyzes the human brainwaves, and translates the brainwaves into a command or request for the dog 1002. The system for AI-enabled interspecies communication 1020 can encode the command in a haptic and/or audio representation that is sent to the brainwave sensor auxiliary module 1008 via network 1024. The brainwave sensor auxiliary module 1008 can have one or more output devices that include speakers and/or haptic output devices such as vibrators and/or buzzers, to provide biofeedback stimulation to the dog. The dog can be trained to perform a command or action based on the biofeedback stimulation. As a non-limiting example, the human 1030 can think a thought about the dog 1002 sitting down. The brainwaves from the human 1030 corresponding to the thought of the dog sitting down can be detected by the sensor array 1032, and acquired by data acquisition module 1034, which relays the brainwave data to the system for AI-enabled interspecies communication 1020, which can encode the command in a haptic output of three short bursts of vibration that can be felt by the dog 1002 that is wearing the brainwave sensor auxiliary module 1008 on collar 1006. The dog can be trained to sit in response to feeling the three short bursts of vibration. In this way, disclosed embodiments can provide a brain-computer interface (BCI) that can be used for human-machine interaction, animal-machine interaction, animal-animal interaction, and/or human-animal interaction, enabling the functionality of thought-driven commands by humans for control of animals, and/or controlling machinery and/or equipment, such as prosthetics and/or virtual systems.

The environment 1000 can further include other animals, such as whale 1053, and/or dolphin 1051. The whale 1053 can be outfitted with a wearable electronic device 1055, similar to 138 as described in FIG. 1. Similarly, the dolphin 1051 can be outfitted with a wearable electronic device 1057, that includes functionality similar to 138 as described in FIG. 1. Although a dog, whale, and dolphin are shown in the exemplary environment 1000 of FIG. 10, disclosed embodiments are not limited to use with these animals. Other animals, such as cats, horses, oxen, birds, primates, other aquatic animals, and/or other capable animals can also be supported by, and/or make use of, disclosed embodiments.

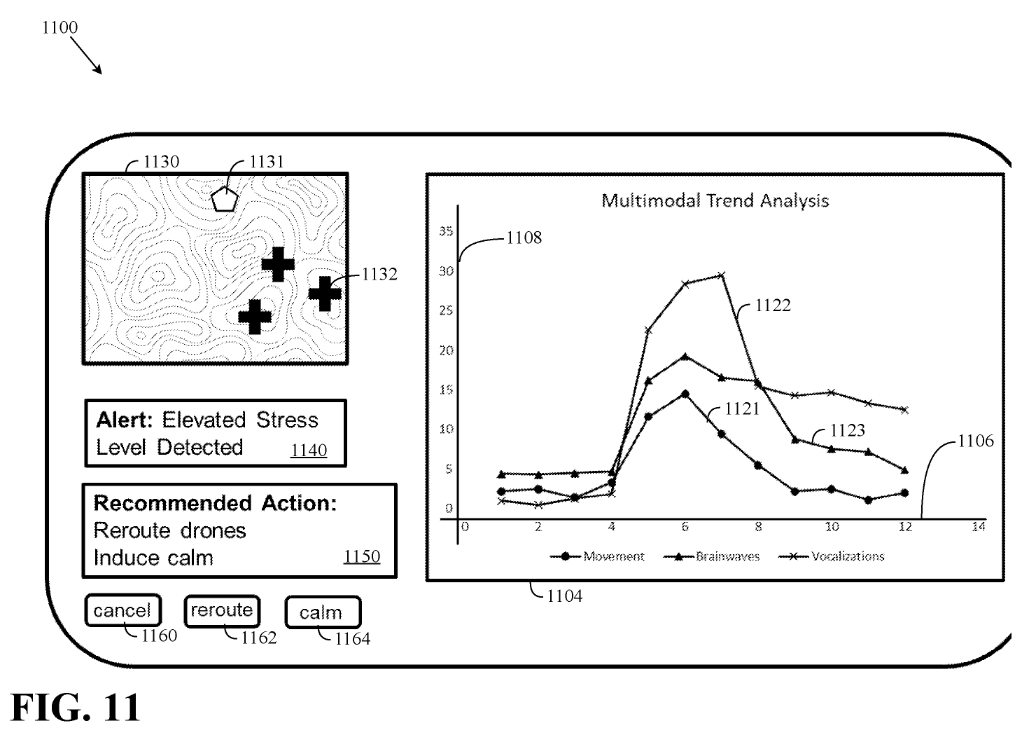

FIG. 11 shows details of an information dashboard used in Monte Carlo tree search-based decision optimization systems for interspecies communication, in accordance with one or more embodiments. Dashboard 1100 can be rendered and presented on an electronic display of a device such as device 1040 depicted in FIG. 10. The dashboard 1100 can include a graphical multimodal trend analysis 1104. The graphical multimodal trend analysis 1104 can indicate a temporal relationship between various modalities, such as movement, brainwaves, and/or vocalizations. The graphical multimodal trend analysis 1104 can include a horizontal axis 1106 representing time. The graphical multimodal trend analysis 1104 can include a vertical axis 1108 representing a magnitude. As shown in FIG. 11, a first curve 1121 represents movement, a second curve 1122 represents vocalizations, and a third curve 1123 represents brainwaves. Some embodiments may include more, fewer, and/or a different number of curves, such as heart rate, body temperature, hormone levels (e.g., cortisol), or environmental variables like ambient noise or proximity to human activity. A peak of all three curves occurring at a similar time can indicate an elevated emotional state. In embodiments, a machine learning system is trained to interpret relationships between different modalities as it relates to animal emotional state, and/or communicative intent. For example, the relationship of the three curves shown in graphical multimodal trend analysis 1104 can indicate elevated movement, increased vocalization, and increased brainwave activity all occurred at approximately the same time. A trained AI model can further be configured to identify context-dependent anomalies, such as when elevated emotional state corresponds to the presence of nearby vehicle activity, sudden changes in temperature, or proximity of other species (e.g., predators). In embodiments, a trained AI model can make an inference based on the trend of the multiple modalities. The inference can be used to generate an alert. The alert can be rendered and presented as part of the dashboard 1100, as indicated at 1140. Embodiments can include rendering and presenting an alert message on the real-time orchestration dashboard. The inference can further be used to generate a recommended action. Embodiments can further include rendering and presenting a recommendation action on the real-time orchestration dashboard, wherein the recommendation action is based on the alert message. The recommended action is shown at 1150. In the example, the recommended actions include rerouting drones, and inducing calm, as shown at 1150. Additional actions can include notifying reserve rangers, initiating an automated deterrent system for suspected poachers, or activating cameras to capture video evidence of unusual activity. In an example use case, wildlife, such as elephants, may be monitored by drones to check for poachers or any other unsafe conditions. While under normal conditions, an elephant may not notice a drone, in a heightened emotional state, noise from a drone could cause additional stress for the elephant. The rerouting of the drone can include moving the drone to another area, and/or increasing the altitude of the drone as part of a noise abatement policy. In some cases, the drone can enter a passive hover mode or alter its flight pattern to minimize disturbance while maintaining visual contact. The inducing of calm can include emitting soothing sounds and/or scents from an electronic device that is worn by the animal. In some implementations, these devices may also use mild vibration cues to direct the animal to calmer regions of the preserve, especially if stress is associated with a known geographic area. One or more user interface buttons can be rendered and presented in the dashboard 1100 to enable various user control functions. Button 1160, when invoked, causes the system to cancel the alert and recommended actions, removing the alert 1140 and recommended actions 1150 from the dashboard 1100. Button 1162, when invoked, causes the system to send instructions to one or more drones to adjust a location of the one or more drones, and/or an altitude of the one or more drones. Button 1164 may be provided to invoke a calm protocol, which can include emitting scents and/or sounds from wearable electronic devices affixed to the animals being monitored. The scents and/or sounds can include sounds that are known to have a calming effect on the animals.

The dashboard 1100 can further include a geospatial view 1130. In embodiments, the geospatial view 1130 can include animal locations, terrain features, and/or environmental conditions. Icons representing animals update in real-time, displaying status indicators (e.g., different symbols to indicate stress levels, and/or activity patterns). Moreover, the geospatial view 1130 can include symbology to indicate the position of animals, as indicated at 1132. Disclosed embodiments may also detect and/or highlight unusual dispersal patterns on the geospatial view 1130 that might indicate threat or panic. In embodiments, the position of animals may be reported via wearable electronic devices using positional determination and reporting functions such as GPS, WiFi and/or cellular signal triangulation, and/or other suitable techniques. Additionally, the symbology can include a drone location, indicated at 1131. Further, the dashboard may provide weather overlays, sun positioning, or moon phase data, as certain animal behaviors correlate with environmental conditions. In this way, operators can use the information presented by dashboard 1100 to make real-time decisions to protect animals and promote their overall wellbeing. Embodiments can include rendering and presenting a real-time orchestration dashboard on an electronic display, wherein the real-time orchestration dashboard includes a rendering of a geospatial view, a behavioral stream display, and a multimodal correlation display. In embodiments, information shown in the geospatial view 1130 includes information obtained from a Simultaneous Localization and Mapping (SLAM) system. In embodiments, the multimodal correlation display can include overlaying of multiple streams of data, such as depicted in graphical multimodal trend analysis 1104.

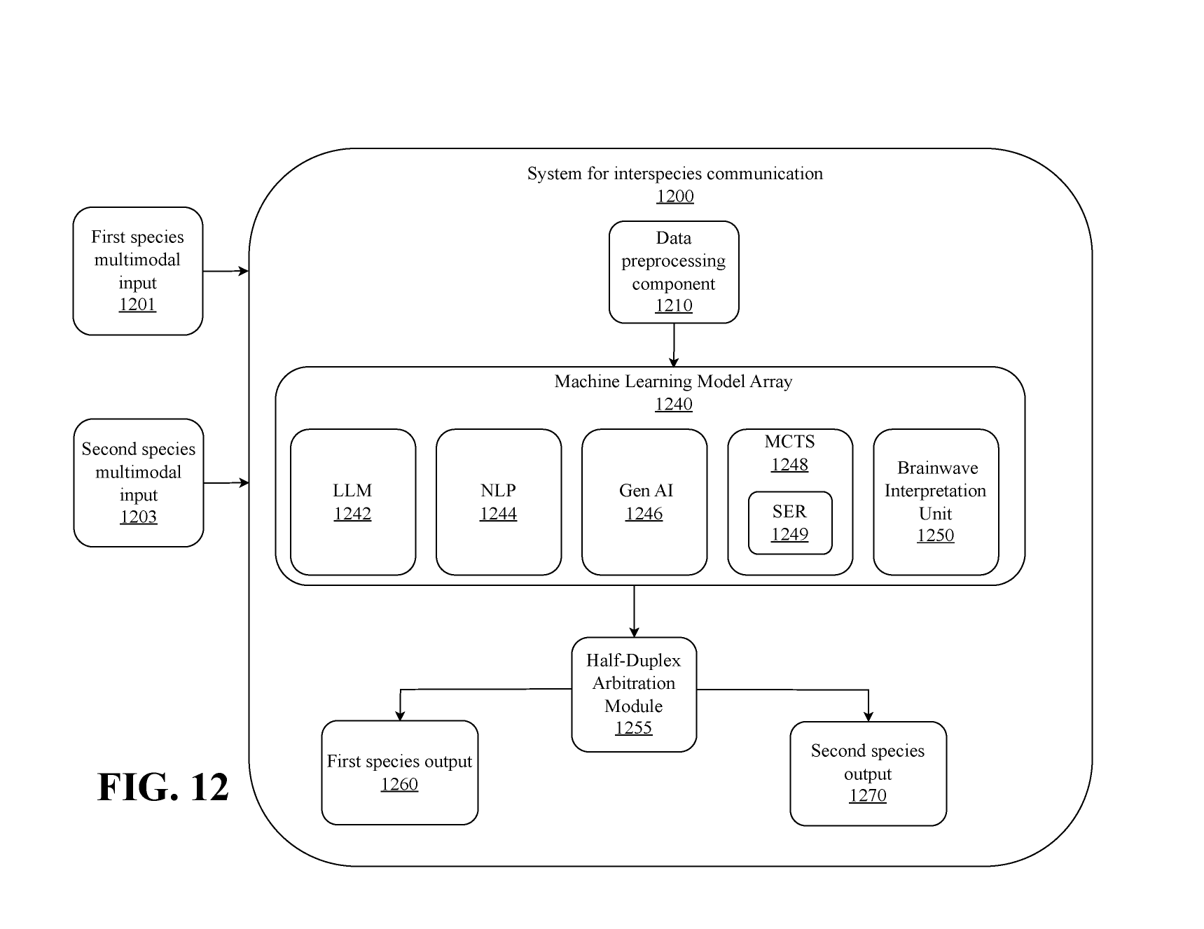

FIG. 12 is a block diagram illustrating components of a Monte Carlo tree search-based decision optimization system for interspecies communication, in accordance with one or more embodiments. System 1200 can receive as input, a first species multimodal input 1201. The first species multimodal input 1201 can include movement signals (e.g., captured from wearable devices that include positional reporting capability (e.g., GPS, RF signal triangulation, etc.), and/or accelerometer (inertial movement) reporting capability. The first species multimodal input 1201 can include brainwave signals. The first species multimodal input 1201 can include vocalization signals (e.g., as detected from an onboard microphone of the wearable electronic device worn by an animal, and/or microphones placed within an environment). System 1200 can receive as an additional input, second species multimodal input 1203, which can include similar types of data as described for the first species multimodal input 1201.

The system 1200 can include a data preprocessing component 1210. The data preprocessing component 1210 can perform data conditioning on signals included in the first species multimodal input 1201 and second species multimodal input 1203. The signal conditioning can include noise reduction techniques such as low-pass filtering to eliminate high-frequency artifacts, frequency domain filtering to isolate specific spectral components of interest (e.g., for vocalization harmonics), and band-pass filtering to target known communication frequency bands used by particular species. Additionally, outlier removal algorithms can be applied to eliminate anomalous spikes in data caused by sensor glitches and/or environmental interference. Temporal alignment and normalization may also be included, to ensure multimodal inputs such as movement, heart rate, and/or audio signals are synchronized and comparable across species. Other preprocessing steps may include Z-score normalization, signal smoothing (e.g., via moving average), baseline drift correction, and/or the interpolation of missing data to improve data quality before feeding into machine learning pipelines. The output of the data preprocessing component 1210 can be input to machine learning model array 1240

Machine learning model array 1240 may include one or more machine learning models, neural networks, and/or other systems for processing and interpreting input data. The machine learning model array 1240 can include a large language model 1242. The large language model (LLM) 1242 can be trained for specific animals (e.g., species-specific or individual-specific) and can ingest continuous streams of neural population data recorded across multiple tasks and states. These models go beyond simple language: they become multimodal encoders of animal neural signals, motor outputs, observed behaviors, and contextual cues. By structuring training data to include “high-incentive” versus “neutral” tasks, the LLM can learn when the animal’s neural signature deviates from its optimal preparatory patterns. In embodiments, the machine-learning system includes a large language model (LLM). In embodiments, the machine-learning system includes a large language model (LLM). In embodiments, the LLM includes a multi-head attention (MHA) mechanism. In embodiments, the MHA can improve self-attention by splitting the input into multiple “heads,” allowing the model to attend to different aspects of the data simultaneously. Each head processes information independently, and their outputs are combined to create a richer representation. In embodiments, the outputs from all heads can be concatenated and passed through a linear transformation to form the final representation.

The machine learning model array 1240 can include a natural language processing (NLP) module 1244. The NLP module 1244 can enable the conversion of human speech to animal-understandable patterns. The NLP module 1244 can include NLP pipelines that parse human language into semantic tokens. These tokens can then be mapped onto a species-specific “neural command embedding space.” For whales, this might involve converting a request such as ‘swim to the surface’ into a neural stimulation pattern, along with an auditory output pattern such as a song or pattern of clicks. For canines, this might involve converting a request like “Fetch the red ball” into a neural stimulation pattern plus a subtle auditory or tactile cue that aligns with the dog’s pre-trained internal representations of the action “fetch” and the visual concept “red ball.”

The machine learning model array 1240 can include a generative artificial intelligence (Gen AI) module 1246. The Gen AI module 1246 can enable supplementing training data with synthesized data, such as vocal data (e.g., canine vocalizations or whale codas), where the vocal data is created with properties such as number and regularity of signal units (clicks, barks), spectral means, and/or amplitude envelopes. The Gen AI module 1246 can include a generative adversarial network (GAN), such as WaveGAN, InfoGAN, fiwGAN, and/or other suitable GAN.

The machine learning model array 1240 can include a Monte Carlo Tree Search (MCTS) module 1248. The MCTS module 1248 can enable adaptive, look-ahead scheduling decisions. Instead of applying fixed heuristics or static load-balancing, disclosed embodiments can simulate and/or evaluate multiple future states of the pipeline before choosing the next action. By repeatedly exploring and exploiting different pipeline routing decisions (e.g., which specialist model to send partial outputs to, or how to scale certain pipeline segments), MCTS can minimize the cumulative regret over time, converging toward near-optimal scheduling policies that are robust to changing conditions, input distributions, and latency constraints. In one or more embodiments, the MCTS module 1248 can enable enhanced resource allocation, such as allocating more GPUs, selecting specialized hardware accelerators, and/or adjusting batch sizes downstream.

The MCTS module 1248 can include a super-exponential regret (SER) module 1249. The SER module 1249 can include functions, instructions, and/or neural network layer implementations for detecting situations where exploration is too aggressive, indicating potential excessive exploration of suboptimal branches, or potential incorrect initial information. This condition may be identified by tracking metrics such as cumulative regret curves, abrupt divergence in expected versus actual rewards, and/or an unusual distribution of exploration probabilities across the tree. Upon detecting a super-exponential regret condition, disclosed embodiments can initiate a model retraining sequence. The model retraining sequence can include taking the system offline, alerting operators, and/or obtaining new training data from a knowledge base of labelled data to use for retraining. In some implementations, retraining may involve reinitializing tree priors, performing targeted reinforcement learning updates, or injecting high-confidence data into early decision layers to re-anchor predictions. A human-in-the-loop approach may also be optionally used to validate critical decision branches before resuming autonomous operation. In this way, disclosed embodiments can monitor the output of the machine learning model array 1240 to reduce the risk of inaccurate inferences. This enhances system robustness and helps ensure that long-term planning via the MCTS remains aligned with real-world conditions and observed outcomes. Embodiments can include performing a super-exponential regret minimization process as part of the MCTS process.

The machine learning model array 1240 can include a brainwave interpretation unit 1250. Brainwave interpretation unit 1250 may utilize machine learning to classify and/or interpret brainwave patterns. The brainwave interpretation unit 1250 can utilize and/or implement Support Vector Machines (SVMs), Principal Component Analysis (PCA), Random Forests, Convolutional Neural Networks (CNNs), Recurrent Neural Networks (RNNs), Autoencoders, and/or other machine learning components. The machine learning can be trained for tasks such as identifying abnormal brainwave patterns linked to epilepsy or cognitive decline, such as detecting when a dog is engaged or distracted to refine training techniques, as well as distinguishing stress, excitement, focus, relaxation, and/or other emotional states in humans and/or animals.

The machine learning model array 1240 can output data to a half-duplex arbitration module 1255. In half-duplex systems, both parties (e.g., human and animal) can send and receive information, but not simultaneously. Instead, communication occurs in a sequenced manner, first one party sends, then the other responds. This is akin to traditional walkie-talkie usage or push-to-talk radio communication, where only one party is transmitting at a given moment. In disclosed embodiments, the half-duplex arbitration module 1255 enforces this mode of communication to simplify the processing needed to perform interspecies communication tasks. Moreover, the half-duplex arbitration model may implement turn-based engagement. The turn-based engagement is a subset of half-duplex arbitration, in which clear “turns” are established. In animal-human communication, the implementation can enforce rules such that when the animal is signaling intent (e.g., detected by multimodal data), the human must wait for a cue that the animal’s “turn” has ended before sending back a command or reinforcement signal. Conversely, once the human has “spoken,” the system blocks immediate animal output until it is processed and a human turn is completed. The turn-based implementation of disclosed embodiments can simplify the decoding pipeline since the system only needs to process one “speaker” at a time. The neural decoding model, for instance, can focus solely on the animal’s neural signals without simultaneously processing incoming human commands. Moreover, by strictly delineating turns, the likelihood that a reinforcement stimulus and the animal’s response signals will overlap and confuse the model is minimized. The turn-based implementation of disclosed embodiments can be beneficial in early training phases when ensuring clarity is paramount. Embodiments can include sending the converted linguistical pattern corresponding to the first species and sending the converted linguistical pattern corresponding to the second species using a half-duplex process.

The output of the half-duplex arbitration module 1255 can be directed to a first species output 1260 and/or a second species output 1270. The first species output 1260 and second species output 1270 can include various output elements. The output elements can support audio output. The audio output can include species-specific audio waveforms such as clicks and songs for cetaceans, growling and/or barking sounds for canines, text and/or speech for humans, and so on. In an aquatic environment such as depicted in FIG. 1, the audio output may be provided by underwater speakers or other suitable transducers. In the terrestrial environment such as depicted in FIG. 10, audio and/or haptic output may be provided by the brainwave sensor auxiliary module 1008 and/or other wearable electronic devices. In embodiments, at least one of the first output element and the second output element comprise an electronic display. In embodiments, at least one of the first output element and the second output element comprise an acoustic transducer.

Referring again to the example depicted in FIG. 10, a human 1030 can give a thought command to the dog 1002 by thinking a thought that is detected via sensor array 1032, and provided to system for AI-enabled interspecies communication 1020 as previously described. The thought command can be converted to haptic and/or audio that is output by brainwave sensor auxiliary module 1008. In disclosed embodiments, the system may utilize a mapping model trained on labeled neural intention data to convert human thoughts into intent-classified actions, which are then transformed into semantically appropriate outputs for the target species. For instance, a “come here” thought could be translated into a specific frequency-range bark or vibration pattern that the dog has been conditioned to understand. In this way, the first species output 1260 and the second species output 1270 can enable interspecies communication. As another example, continuing to refer to FIG. 10, dolphin 1051 can issue vocalizations detected by wearable electronic device 1057, which are provided to system for AI-enabled interspecies communication 1020 as previously described, which in turn translates the dolphin-based vocalizations into whale-based vocalizations, which are then sent to wearable electronic device 1055 of whale 1053. The translation can be facilitated by a neural sequence-to-sequence model that has been trained using supervised learning on paired datasets of dolphin and whale communication signals, including click patterns, whistles, and low-frequency pulses. In this way, different animal species can communicate with each other to perform a task, such as exploration, search-and-rescue, and the like. For example, dolphins could scout a shallow region for obstacles and relay the findings to a whale for deep-water navigation, with each species contributing its natural capabilities to complete a shared objective. The system may further include feedback loops where animals confirm receipt or understanding of the message via observed behavioral cues or secondary vocalizations, allowing the model to improve communication fidelity over time.

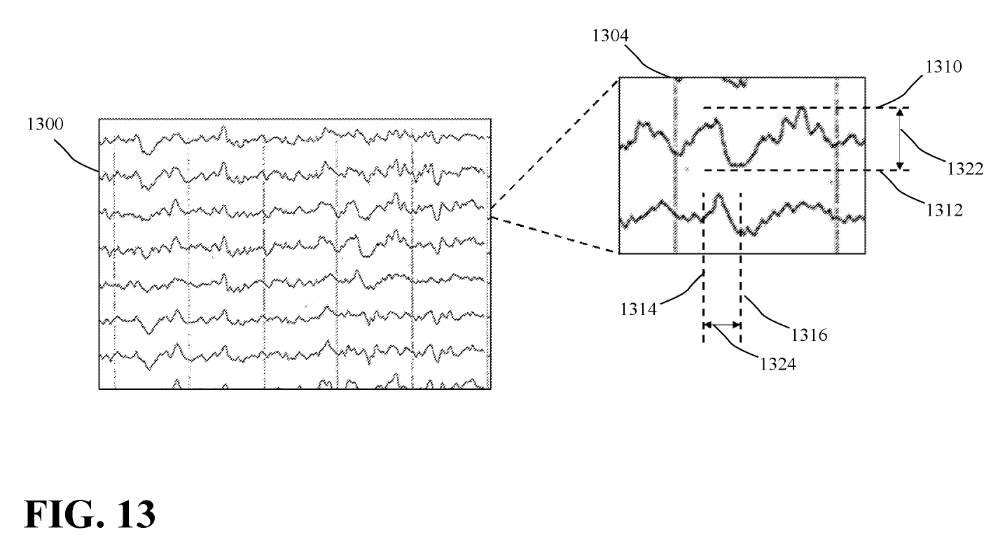

FIG. 13 shows exemplary animal brainwaves that can be analyzed using one or more embodiments. Animal brainwave signals 1300 can be obtained from a sensor such as non-invasive brainwave sensor 1004 shown in FIG. 10. The brainwaves can be representative of EEG (electroencephalography) signals. Section 1304 shows additional details of the brainwaves. The brainwave signals can have a local minimum amplitude 1312 and a local maximum amplitude 1310 with a signal differential 1322. The brainwave signals can have peaks having a starting point 1314 and an ending point 1316, defining a peak duration 1324. In embodiments, the signal differential and peak duration are used as factors in determining emotional and/or cognitive states of non-human animals. In embodiments the animal brainwave signals 1300 can be obtained by non-invasive EEG sensors such as sensors placed on a dog’s scalp that can detect electrical activity. The signals shown in FIG. 13 may be preprocessed by the system 1200 for interspecies communication of FIG. 12. The brainwave signals 1300 may be filtered to remove noise from muscle activity, blinking, and/or environmental interference. The system 1200 for interspecies communication of FIG. 12 may further perform feature extraction on the brainwave signals 1300, in order to extract frequency-domain and/or time-domain characteristics, including delta, theta, alpha, beta, and/or gamma waves.

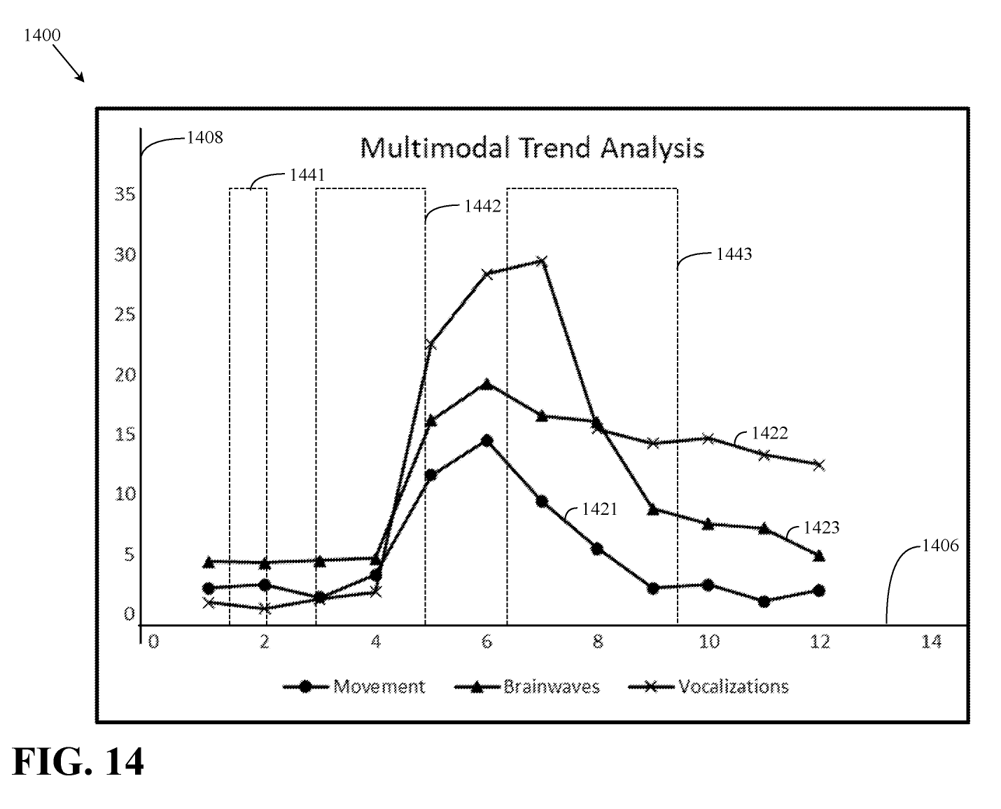

FIG. 14 is a diagram illustrating sliding time windows used in multimodal trend analysis, in accordance with one or more embodiments. FIG. 14 shows a multimodal trend analysis similar to multimodal trend analysis 1104 shown in FIG. 11. Similar to as described previously, the graphical multimodal trend analysis 1400 can include a horizontal axis 1406 representing time. The graphical multimodal trend analysis 1400 can include a vertical axis 1408 representing a magnitude. The magnitude can be derived by applying a normalized value based on an expected maximum and minimum range for each signal type, using domain-specific heuristics or data-driven calibration, such as z-score normalization or min-max scaling, to ensure comparability across different data modalities. A first curve 1421 represents movement, a second curve 1422 represents vocalizations, and a third curve 1423 represents brainwaves. Each curve may have its own sliding time window which is used as a filtering parameter. Sliding time window 1441 corresponds to curve 1421. Sliding time window 1442 corresponds to curve 1422. Sliding time window 1443 corresponds to curve 1423. Disclosed embodiments can maintain multiple sliding time windows that capture data streams from multiple modalities, such as neural signals from animal-wearable electrodes, vocalizations captured by on-collar microphones, and gestural/body posture data from inertial sensors or camera-based vision systems. Each modality can have different temporal characteristics and reliability profiles. For example, brainwave data may be processed with short-duration, high-resolution windows (e.g., 250 milliseconds) to capture rapid cognitive state transitions, while vocalizations may use slightly longer windows (e.g., 1–2 seconds) to accommodate the onset and duration of calls. Movement data, being more gradual, may use even longer windows (e.g., 3–5 seconds) to smooth out noise and capture sustained behavioral trends. By leveraging these windows and adaptive lookback/lookahead strategies, the system can continuously refine its interpretations of the animal’s cognitive and emotional states. The adaptive nature of the windows can be governed by a scheduler or controller component that dynamically adjusts time window durations based on signal volatility, data confidence, and recent event detections, thereby optimizing responsiveness without sacrificing accuracy. Embodiments can include: obtaining first vocalization data from the first species; obtaining second vocalization data from the second species; obtaining first brainwave data from the first species; obtaining second brainwave data from the second species; obtaining first movement data from the first species; obtaining second movement data from the second species; and providing the first vocalization data, second vocalization data, first brainwave data, second brainwave data, first movement data, second movement data, as input data to a Multimodal Temporal Segmentation Module (MTSM) to generate one or more sliding time windows pertaining to the input data.

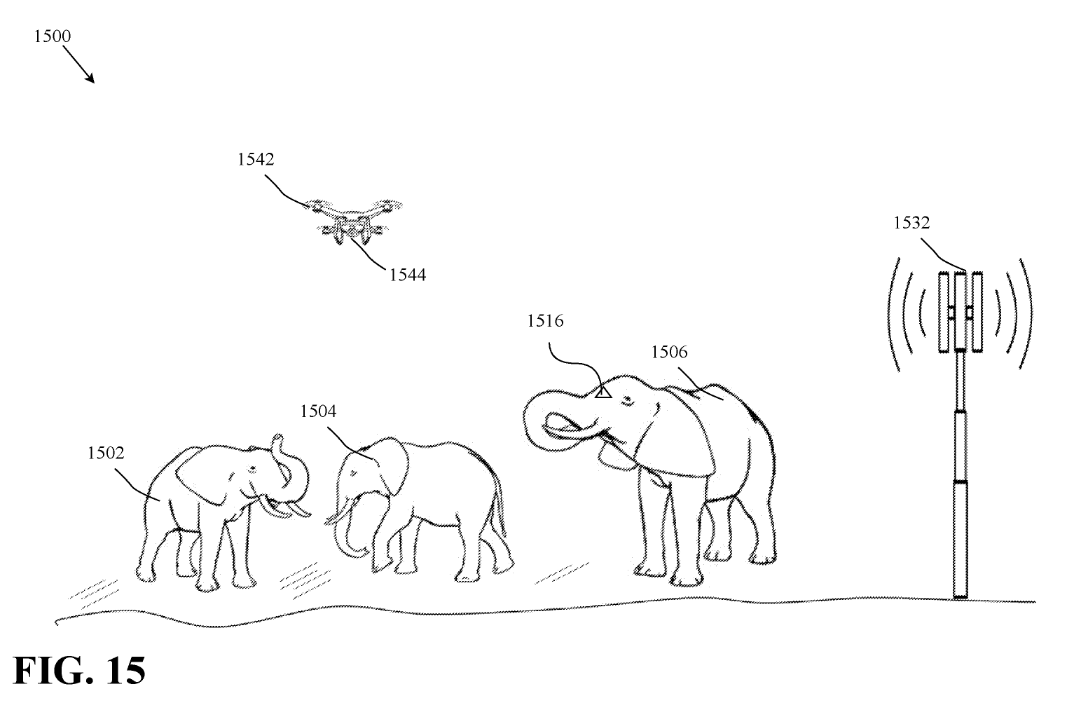

FIG. 15 shows another exemplary environment 1500 in which Monte Carlo tree search-based decision optimization systems for interspecies communication can be used, in accordance with one or more embodiments. Environment 1500 includes multiple elephants, indicated at 1502, 1504, and 1506. While elephants are shown in this example, the environment 1500 can include other animals, including wild animals, as well as livestock and domestic animals. In embodiments, a drone 1542 can operate airborne above the elephants. The drone 1542 can include a sensor array 1544 which can include one or more visible cameras, infrared cameras, hyperspectral cameras, LiDAR, and/or other sensing devices. The drone 1542 can further include a wireless data transceiver that can transmit data to radio tower 1532 to enable sending of data acquired by the drone 1542 to the system for AI-enabled interspecies communication 1020 of FIG. 10. The drone 1542 can further include a speaker to output sounds that the elephants may hear, and/or output noise cancellation signals to reduce the perceived noise of the drone. The drone may further include a scent dispenser to dispense a scent that the elephants may detect. In embodiments, the scent may include a scent that invokes calm in an elephant, such as lavender (Lavandula angustifolia), sandalwood (Santalum album), marula fruit (Sclerocarya birrea), and/or other scents that may be empirically determined to induce calm in elephants.

One or more of the elephants may further include a non-invasive biosensor, such as indicated at 1516 on elephant 1506. The non-invasive biosensor may include one or more electrodes, a power source, a signal acquisition module, a position tracker (e.g., GPS), and/or a wireless communication module. In embodiments, the non-invasive biosensor 1516 may send data to the drone 1542 and/or radio tower 1532 for upload to the system for AI-enabled interspecies communication 1020 of FIG. 10. In embodiments, the non-invasive biosensor can obtain biometric data from an animal, such as heart rate, body temperature, perspiration rate, breathing rate, and so on. The biometric data can further include brainwave signals. The combination of the biometric data and the data from the sensor array 1544 of the drone 1542 may be sent to the system for AI-enabled interspecies communication 1020 of FIG. 10 for further analysis and/or processing.

In embodiments, invoking button 1164 of the dashboard shown in FIG. 11 causes the drone 1542 to emit a scent that is calming for elephants, such as previously stated. Based on dashboard information (e.g., from dashboard 1100 of FIG. 11), it may be detected that the elephants are in a stressed state. A calming protocol can be initiated (e.g., via button 1164 as shown in FIG. 11). In one or more embodiments, the drone 1542 can be configured to initiate calming actions. The calming actions can include relocating the drone further away, and/or at a higher altitude to reduce noise level. In the example of FIG. 15, the calming process can include providing the elephants with calming scent patterns or gentle auditory signals, encouraging the elephants to return to a calmer state. The auditory signals can include low-frequency sounds, nature sounds (e.g., rainfall, flowing streams, and/or distant thunder), and/or soft, slow-tempo classical music (e.g., slow pieces from Debussy, Chopin, and/or Beethoven). Zoos and sanctuaries have reported that elephants sometimes become noticeably more relaxed when exposed to this kind of music. The calming process serves to promote interspecies communication, as a calmer animal is more likely to think clearer, and respond rationally.

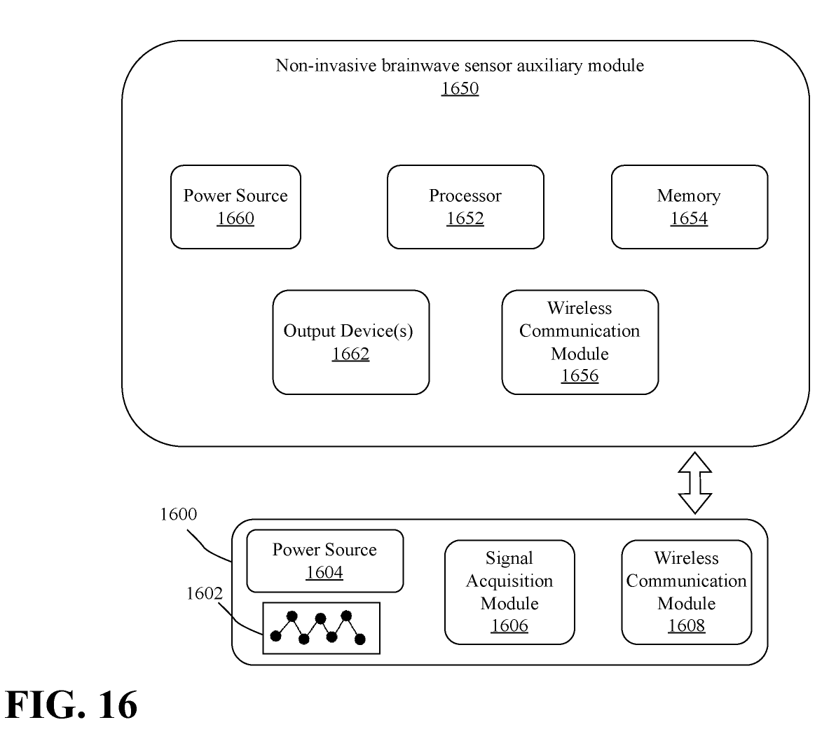

FIG. 16 shows a block diagram of an exemplary non-invasive sensor, in accordance with one or more embodiments. Sensor 1600 can include a substrate 1602 that can serve as electrodes. The substrate can include a spray-on conductive polymer ink (e.g., PEDOT:PSS) and/or ultra-flexible tattoo electrodes to map neural signals from an animal’s head (e.g., a dog’s head). In embodiments, the substrate 1602 can be applied to the skin of an animal via a biodegradable adhesive. In some embodiments, a small area of the animal’s head may be shaved to expose a patch of skin for application of the substrate 1602. Thus, embodiments can include a flexible, biocompatible film that is applied to targeted regions of the animal’s scalp, avoiding areas of thick fur by carefully shaving an area. Other embodiments may utilize an optimized spray formula that can penetrate sparse fur layers. In some embodiments, the conductive polymer ink is doped with additives such as sodium chloride (NaCl) for low contact impedance and enhanced signal acquisition.

In embodiments, captured signals are amplified by lightweight, on-body electronics integrated into the tattoo design or attached nearby on a collar-mounted processing unit. In embodiments, the tattoo is formulated for high adhesion and stretchability to withstand the animal’s natural movements and environmental conditions, such as running, jumping, or exposure to moisture. In embodiments, the animal’s fur may be trimmed in the area where the sensor 1600 is to be applied, prior to applying the sensor 1600. Sensor 1600 can be a scalp-mounted sensor, such as depicted at 1004 in FIG. 10. In embodiments, the sensor 1600 can be applied on a dog’s scalp near the olfactory bulb. The sensor 1600 can further include a power source 1604. The power source 1604 can include a replaceable coin cell battery, rechargeable battery, and/or other suitable battery type. The battery can include a lithium-ion battery. The battery can provide power to signal acquisition module 1606 and wireless communication module 1608. The signal acquisition module 1606 can include an ADC (analog-to-digital converter) that is fed a filtered input from a filter section that can include low-pass filters to remove high-frequency noise. The signal acquisition module 1606 can further include instrumentation amplifiers, programmable gain amplifiers, and/or other suitable amplifiers for boosting weak signals for further processing. The signal acquisition module 1606 may further include a clock generator to provide timing for the ADCs. The signal acquisition module may further include a microcontroller for control of the amplifiers and/or ADCs. The microcontroller can include an ARM Cortex processor, RISC-V processor, and/or other suitable processor type.

The wireless communication module 1608 can support protocols such as Near Field Communication (NFC), Bluetooth Low Energy (BLE), RFID (Radio Frequency Identification), and/or other suitable protocols. The wireless communication module 1608 can include one or more modulators that may provide FSK (Frequency Shift Keying), ASK (Amplitude Shift Keying), and/or PSK (Phase Shift Keying) modulations. The wireless communication module may further include a microcontroller for control of the modulators and/or amplifiers and other associated components. The microcontroller can include an ARM Cortex processor, RISC-V processor, and/or other suitable processor type. In embodiments, the non-invasive brainwave sensor further comprises a wireless data transmission module. In embodiments, the wireless data transmission module includes a Bluetooth Low Energy (BLE) module.

The sensor 1600 can interoperate with the non-invasive brainwave sensor auxiliary module 1650. The non-invasive brainwave sensor auxiliary module 1650 can be a collar-mounted processing unit such as depicted at 1008 in FIG. 10. The non-invasive brainwave sensor auxiliary module 1650 can include a processor 1652. The processor 1652 can include an ARM Cortex processor, RISC-V processor, and/or other suitable processor type. The processor 1652 can be coupled to memory 1654. The memory 1654 can include a combination of random-access memory (RAM), read-only memory (ROM), Flash memory, and/or other suitable memory type. The non-invasive brainwave sensor auxiliary module 1650 can include a power source 1660. The power source 1660 can include a replaceable battery, rechargeable battery, or other suitable battery type. The non-invasive brainwave sensor auxiliary module 1650 can include a wireless communication module 1656. The wireless communication module 1656 may include components to enable communication with wireless communication module 1608 of the sensor 1600. As stated previously, this can include antennas and modulators for as Near Field Communication (NFC), Bluetooth Low Energy (BLE), RFID (Radio Frequency Identification), and/or other suitable protocols. Additionally, the wireless communication module 1656 may include components to support longer distance communication, such as WiFi, cellular network communication, and/or satellite-based communication. This can enable relay of brainwave data to the system for AI-enabled interspecies communication 1020 as shown in FIG. 10. The non-invasive brainwave sensor auxiliary module 1650 can include one or more output devices 1662. The output devices can include one or more LED (light-emitting diode) lights, a speaker, a haptic device (e.g. vibrator, buzzer, etc.), and/or other suitable output devices. The LED light can convey an operational status, such as being online, offline, low battery, etc. The speaker can be used to emit sounds and/or voice data that can be heard by the dog 1002. The haptic device can impart sensations of vibration or pulsing that can be felt by the dog as stimulus in response to commands that are verbally given or otherwise conveyed by a human (e.g., human 1030 of FIG. 10). In embodiments, a dog can be trained to respond to the output from the speaker and/or haptic device to carry out commands that are provided by a human based on human language and/or thought patterns.

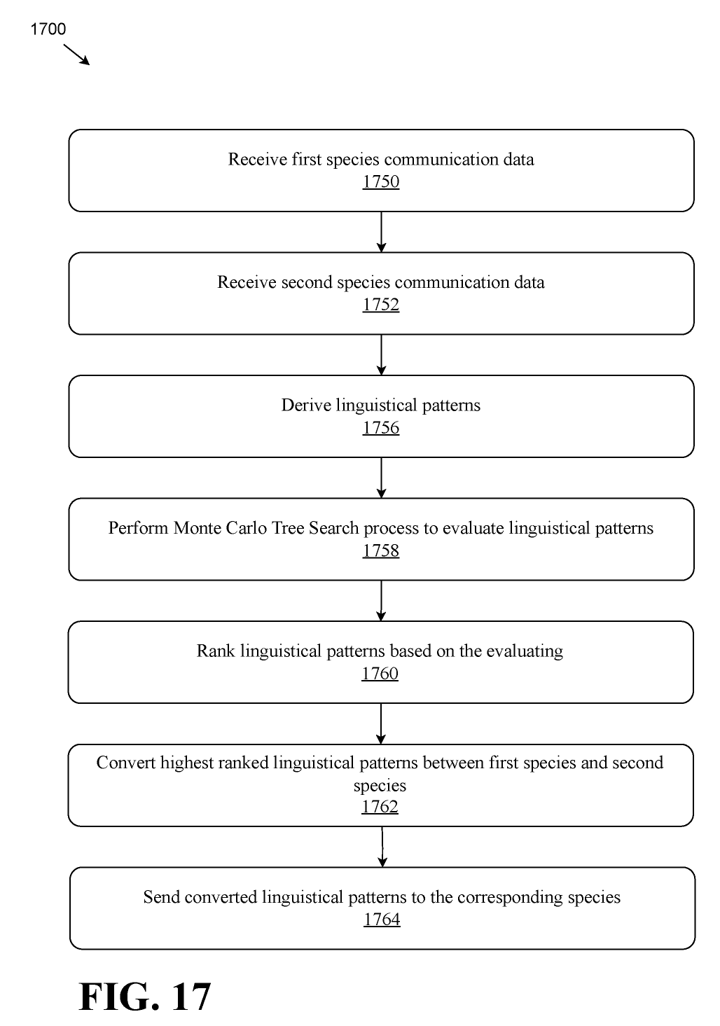

FIG. 17 is a flow diagram illustrating an exemplary method for Monte Carlo tree search-based decision optimization for interspecies communication, according to one or more embodiments. The method 1700 starts with receiving first species communication data at block 1750. The first species communication data can include vocalization data, movement data, gesture data, facial expression data, biometric data, brainwave data, and/or other suitable communication data. In some embodiments, wearable devices, embedded sensors, and edge-based processing units collect and pre-filter these data streams to reduce bandwidth and latency during transmission to AI-enabled interspecies communication 1020 of FIG. 10. The method 1700 continues with receiving second species communication data at block 1752. The second species communication data can include vocalization data, movement data, gesture data, facial expression data, biometric data, brainwave data, and/or other suitable communication data. The use of multiple sensory channels can enable disclosed embodiments to identify interspecies intent and emotion with higher robustness, even in noisy or low-visibility environments.

The method 1700 continues with deriving linguistical patterns at block 1756. The linguistical patterns can include patterns that are associated with a known animal behavior and/or sentiment. For example, a certain type of growl in a dog can indicate fear, excitement, and/or other emotion. The derivation step can include temporal pattern analysis, spectral feature extraction, and/or multimodal fusion techniques to correlate vocal, physiological, and motion cues. In embodiments, behavioral databases curated from wildlife experts and animal trainers can be used to label and validate specific patterns during training.

The method 1700 continues with performing a Monte Carlo Tree Search process to evaluate linguistical patterns at block 1758. The Monte Carlo Tree Search process can serve to prevent excessive exploration and also monitor the health of the machine learning inferences. Each node in the Monte Carlo Tree can represent a potential interpretation or communicative intent, and leaf nodes may trigger specific recommended actions or response generation modules. Adaptive reward functions can be used to incorporate contextual factors, such as stress levels, urgency, or mission-critical priorities (e.g., poaching alerts in wildlife preserves).

The method 1700 continues to block 1760 where the linguistical patterns are ranked based on the evaluation. The ranking can include ranking based on a confidence level when multiple possible inferences exist. For example, a vocalization can have a higher likelihood of indicating fear, rather than curiosity. In embodiments, a Bayesian confidence estimation module can be used to model uncertainty, and thresholds can be adjusted based on species-specific behavioral baselines. Ranked patterns can be stored for further auditing and training dataset enrichment.

The method 1700 continues to block 1762, where the highest ranked linguistical patterns between the first species and the second species are converted. This can include converting barks and yelps of a dog into sounds that a primate may understand, and/or converting the barks and yelps into verbal instructions for a human, and so on. Similarly, commands from a primate and/or human can be converted to sounds that a dog can recognize and respond to. In some embodiments, the conversion includes a synthesis layer that transforms input features into species-appropriate output signals using a trained generative model, such as a variational autoencoder or a neural vocoder. In embodiments, the output can be delivered via embedded speakers, ultrasonic emitters, and/or haptic actuators.

The method 1700 continues with sending the converted linguistical patterns to the corresponding species at block 1764. In embodiments, the sending involves utilizing half-duplex communication, such as enabled by half-duplex arbitration module 1255 of FIG. 12. The half-duplex arbitration prevents communication overlap or cross-species confusion, especially when multiple animals are interacting in the same zone. Synchronization techniques such as token passing or time-slot allocation can be employed to manage turn-taking behavior.

In this way, disclosed embodiments can foster improved interspecies communication, enabling collaboration between humans, various animal species, and/or robots, for a wide variety of tasks, such as search-and-rescue, surveillance, and more. Additional use cases may include cooperative foraging, behavioral therapy for traumatized animals, real-time behavioral training, and habitat monitoring using animal-borne sensor relays. The integration of explainable AI techniques further helps human operators understand how decisions are made, building trust in interspecies communication systems.

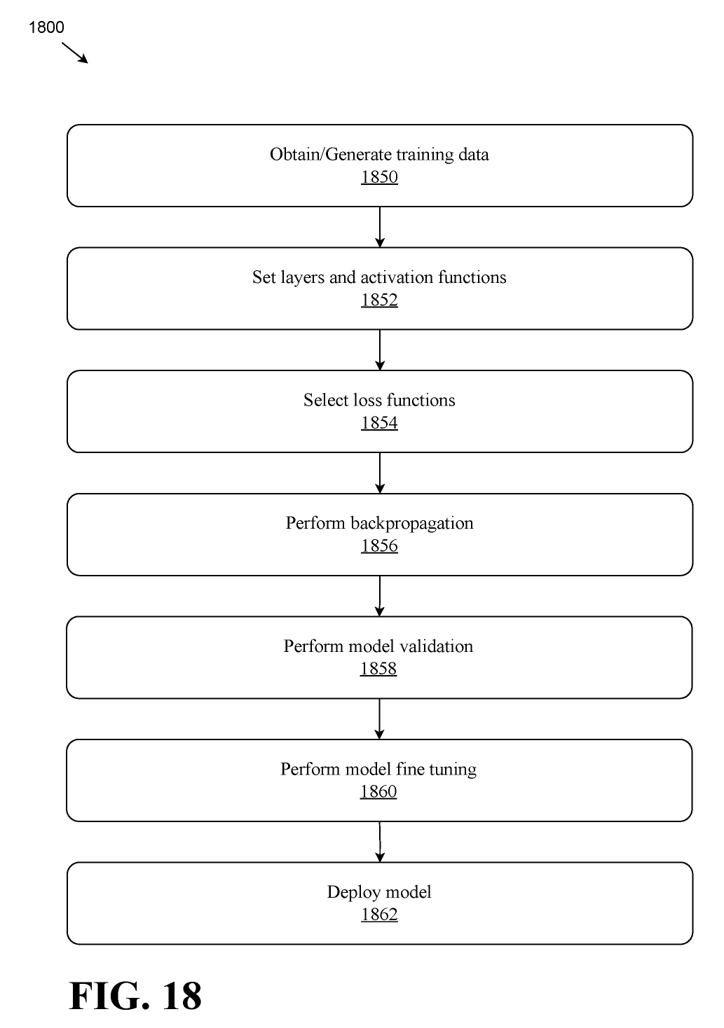

FIG. 18 is a flow diagram illustrating an exemplary method for training a system for AI-enabled interspecies communication, according to one or more embodiments. The method 1800 starts with obtaining and/or generating training data at block 1850. The training data can include human communication data, non-human animal communication data, as well as synthesized data that is generated for supplementing human communication data and/or non-human animal communication data. The synthesized data can be derived from a generative AI network, such as a GAN. The method 1800 continues with setting layers and activation functions at block 1852. In a neural network, layers are the building blocks that form the structure of the network. Each layer comprises a collection of neurons (also called nodes or units), and each neuron performs a specific computation on the input data. The output of one layer becomes the input to the next layer, creating a series of transformations from the input to the output. The layers can include input layers, output layers, and/or hidden layers. The activation functions introduce non-linearity into the model, allowing it to learn and represent complex patterns in the data. In embodiments, the activation functions can include a sigmoid function, a hyperbolic tangent function, a rectified linear unit (ReLU), a Leaky ReLU, softmax function, and/or other suitable activation function. The method 1800 continues to block 1854 for selecting loss functions. The loss functions are mathematical functions used in machine learning to measure the difference between the predicted values produced by the model and the actual target values from the training data. In one or more embodiments, the loss functions can include Mean Squared Error (MSE), Mean Absolute Error (MAE), Categorical Cross-Entropy, and/or other suitable loss functions. The loss functions can be used to determine if the model is sufficiently trained. The method 1800 continues to block 1856 for training the model using backpropagation. The backpropagation process can include computing gradients of the loss with respect to the weights and biases in the output layer. These gradients are propagated backward through the neural network to the hidden layer. The method 1800 continues to block 1858, where the model is validated. The validation can include using an additional set of non-human animal communication data that was not part of the original training dataset as a test dataset. The non-human animal communication data can be translated to human communication data to confirm proper operation of the model. The method 1800 can include model fine-tuning at block 1860. The model fine-tuning can include adjusting weights and/or other hyperparameters as needed to improve model output. The method 1800 continues to block 1862, where the model is deployed for use in performing AI-enabled interspecies communication.

As can now be appreciated, disclosed embodiments can provide AI-enabled interspecies communication that facilitates seamless collaboration between humans and multiple animal species. By translating vocalizations, gestures, and biometric signals across species, the system enables cooperative task execution in real time. This can be particularly valuable in scenarios such as search-and-rescue operations, where dogs, dolphins, and/or elephants may assist human teams by relaying information, identifying targets, or navigating difficult terrain. Similarly, the system can support exploration efforts in remote or hazardous environments, where animals may serve as early warning agents or mobile sensor platforms. Additional advantages can include enhanced animal welfare through stress detection and mitigation, improved training outcomes using personalized communication, and enriched human-animal bonds through mutual understanding. The ability to monitor, interpret, and translate intent across species expands the frontier of multispecies collaboration and opens new avenues for conservation, education, security, and beyond.

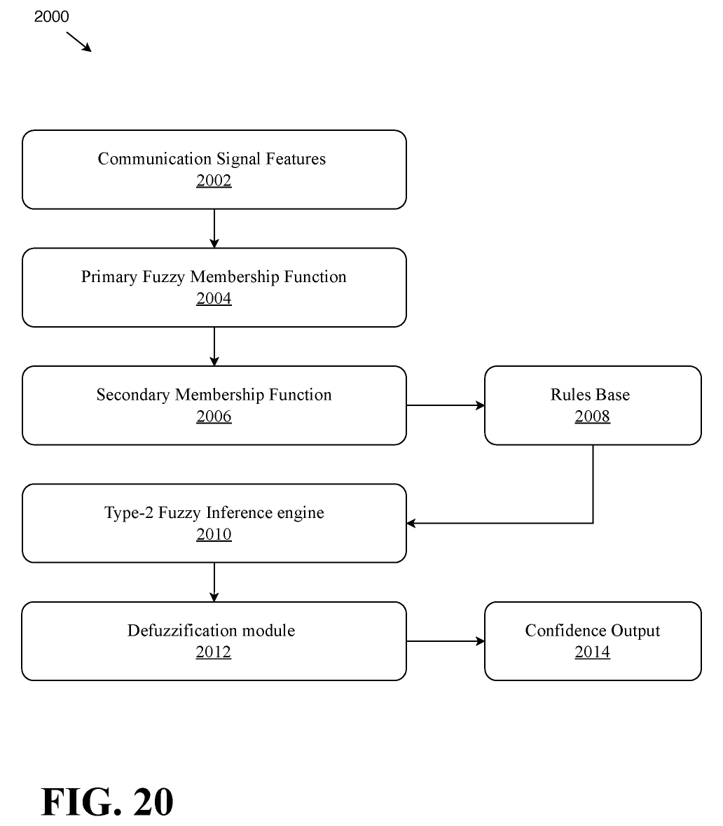

FIG. 20 is a block diagram illustrating a type-2 fuzzy logic architecture for a Confidence-Aware Fuzzy Logic Approximation Engine (CAFLAE), in accordance with one or more embodiments. The architecture depicted in FIG. 20 may be used within the context of interpreting interspecies communication signals where uncertainty is inherent due to biological variability and incomplete knowledge.

In embodiments, the system receives communication signal features 2002, such as vocalization frequency patterns, neural activation waveforms, or movement vectors. These features are first input to a Primary Fuzzy Membership Function Layer 2004, which is configured to model aleatory uncertainty, such as natural variability across repeated animal vocalizations or neural signal fluctuations due to emotional state or environmental noise. This layer maps crisp input values to fuzzy sets that represent the possible interpretation ranges for each signal feature.

The resulting primary membership functions are provided to a Secondary Membership Function Layer 2006, which models epistemic uncertainty—that is, uncertainty about the correctness or completeness of the fuzzy sets themselves. For example, the system may be unsure whether a particular movement gesture implies aggression or playfulness due to insufficient training data. In such cases, a secondary fuzzy membership function can represent the degree of confidence in the fuzzy set’s definition.

The outputs from the primary and secondary membership function layers are then applied to a Rule Base 2008, which contains a set of adaptive fuzzy logic rules. These rules are continuously updated based on real-time feedback from ongoing interactions, reinforcement learning loops, and crowd-sourced or expert-tagged data. The rules are structured to handle multi-species, multi-modal data and support context-aware interpretation of ambiguous inputs.

The results from the rule base are input to a Type-2 Fuzzy Inference Engine 2010, which computes the fuzzy outputs from the activated rules. The inference engine accounts for both levels of uncertainty—aleatory and epistemic—during the reasoning process.

The fuzzy outputs are then processed by a Defuzzification Module 2012, which converts the fuzzy inference results into crisp, confidence-weighted interpretations. This module may implement center-of-gravity or enhanced centroid-based methods adapted for type-2 fuzzy sets, and may also apply weighting based on the relative credibility of rules and membership function sharpness.

Finally, the result is sent to a Confidence Output Unit 2014, which outputs the quantified interpretation (e.g., “gesture implies curiosity”) along with a numerical confidence score (e.g., 0.72). In one or more embodiments, the confidence output can be used by downstream systems to trigger alerts, adjust model parameters, or solicit human validation when the confidence is below a threshold. In this way, CAFLAE enables robust, dynamic handling of uncertainty in multimodal, cross-species communication, significantly enhancing the reliability and interpretability of AI-generated translations in complex or noisy real-world environments.

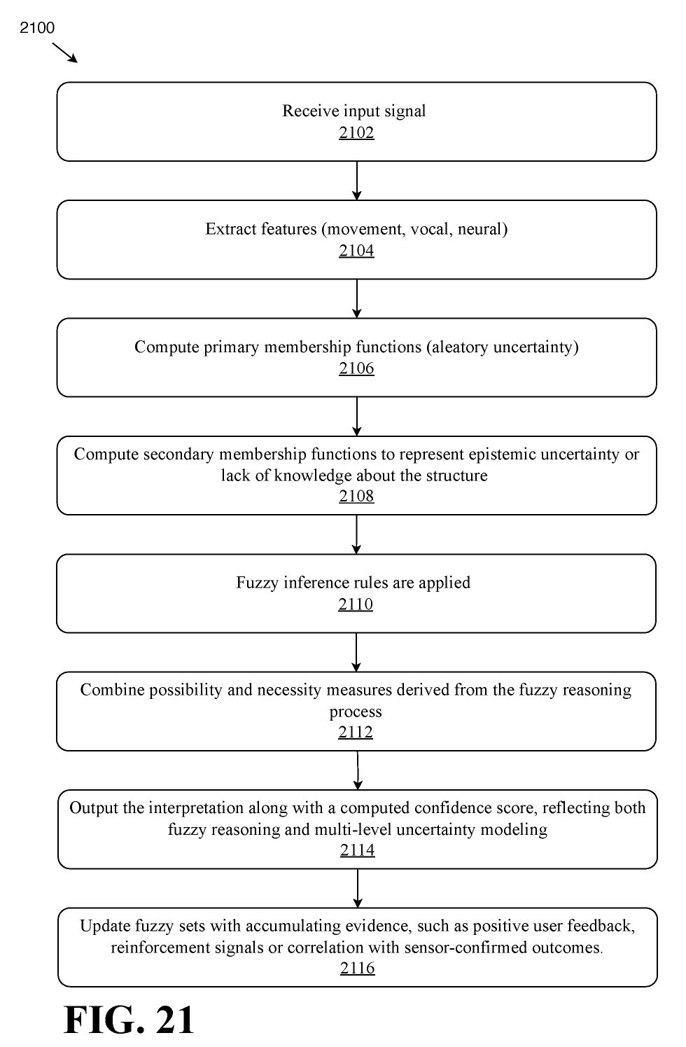

FIG. 21 is a flow diagram illustrating an uncertainty propagation process used in a Confidence-Aware Fuzzy Logic Approximation Engine (CAFLAE), in accordance with one or more embodiments. The method 2100 of FIG. 21 depicts the sequential stages of processing multimodal communication signals through fuzzy logic operations that model both aleatory and epistemic uncertainty.

At block 2102, the system receives an input signal, which may include animal communication data such as vocalizations, movement data from sensors (e.g., accelerometers, GPS), or brainwave activity captured by wearable neural sensing devices. In step 2104, the system performs feature extraction, isolating relevant data attributes from the input signal. These features may include temporal frequency of vocal bursts, gesture speed, orientation vectors, or characteristic waveforms within EEG/EMG signals.

In block 2106, the system computes primary membership functions, representing aleatory uncertainty—that is, inherent signal variability due to biological, environmental, or emotional fluctuation. These fuzzy membership functions map signal features to degrees of belonging for various interpretive states. At step 2108, the system computes secondary membership functions to represent epistemic uncertainty, or lack of knowledge about the structure and validity of the primary membership functions themselves. This second layer enables the system to quantify how uncertain it is about its own interpretations, which is particularly useful when operating with novel species or incomplete training datasets.

In block 2110, fuzzy inference rules are applied. These may include adaptive rule sets that map combinations of fuzzy memberships (primary and secondary) to high-level interpretations (e.g., aggression, curiosity, territoriality). The rule set may be dynamic and updated during training or through real-world feedback. Next, in step 2112, the system combines possibility and necessity measures derived from the fuzzy reasoning process. Possibility indicates how plausible a given interpretation is, while necessity quantifies the minimal confidence level that can be assured. These are combined to produce a bounded confidence interval for the output.

At block 2114, the system outputs the interpretation along with a computed confidence score, reflecting both fuzzy reasoning and multi-level uncertainty modeling. This output may be used to generate multimodal translations (e.g., audio cues, display text, or robotic commands), or it may trigger alerts or recommendations in downstream modules. In step 2116, the system updates fuzzy sets with accumulating evidence, such as positive user feedback, reinforcement signals, or correlation with sensor-confirmed outcomes. This adaptive learning capability enables continuous refinement of the membership functions, especially in low-data or noisy environments. In this way, FIG. 21 provides a schematic representation of how CAFLAE propagates, evaluates, and adapts to different types of uncertainty in interspecies communication, enabling robust, interpretable, and confidence-aware interactions.

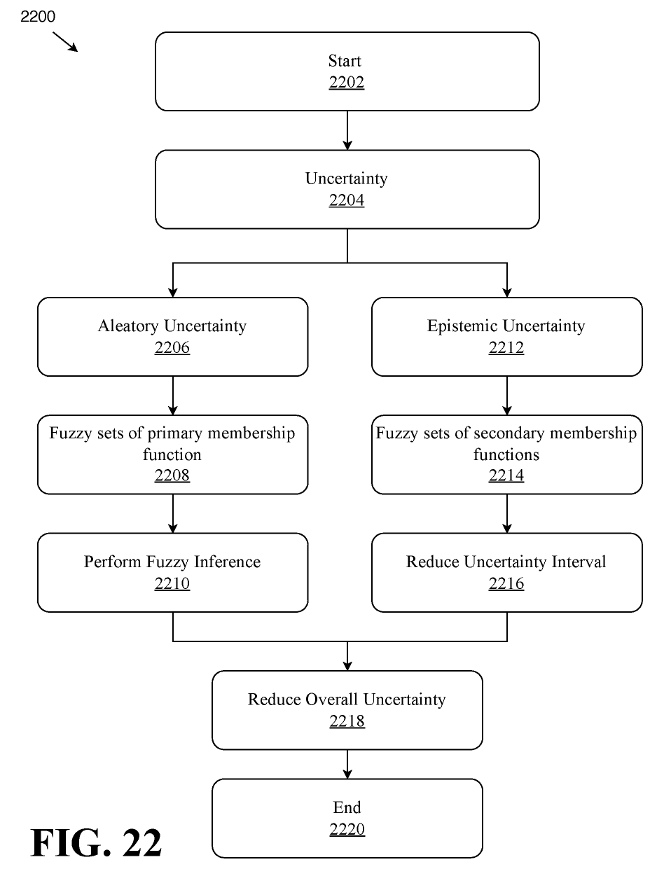

FIG. 22 is a conceptual diagram illustrating the modeling and handling of aleatory and epistemic uncertainty within the Confidence-Aware Fuzzy Logic Approximation Engine (CAFLAE), in accordance with one or more embodiments. The figure demonstrates the distinct processing paths taken to address different categories of uncertainty, which are ultimately integrated to produce a robust, confidence-weighted interpretation of interspecies communication signals.

The process beings at start 2022, followed by a general uncertainty recognition stage 2204, where the system detects the presence of uncertainty in input signals. The uncertainty is bifurcated into two distinct streams: at block 2206 aleatory uncertainty is defined as uncertainty arising from inherent randomness or natural variability in the signal source. This includes changes in animal vocal patterns due to emotion, fatigue, or context. At block 2208, this form of uncertainty is modeled through fuzzy sets of primary membership functions, which define the likely range of interpretation for a given signal feature (e.g., amplitude of a bark, frequency of a whale call). At block 2210, the system performs fuzzy inference, applying rule-based reasoning over the defined fuzzy sets to produce intermediate linguistic interpretations. At block 2212, epistemic uncertainty is identified as arising from lack of knowledge about how to correctly interpret signal patterns—typically due to limited training data, unseen contexts, or unmodeled inter-species behaviors. At block 2214, this form of uncertainty is modeled using fuzzy sets of secondary membership functions, which are built over the primary fuzzy sets and encode a meta-level uncertainty (i.e., uncertainty about uncertainty). At block 2216, the system applies interval bounding or entropy-based methods to reduce the uncertainty interval, using accumulated feedback, observed correlations, or expert refinement to shrink ambiguity in the interpretation process.

Both branches converge at block 2218, where the system produces a reduced overall uncertainty output, which integrates aleatory and epistemic evaluations into a single representation. This output may be used to inform downstream components, such as real-time dashboards, multimodal communication translators, or robotic control units. The process concludes at end 2220, completing one cycle of uncertainty-aware interpretation. In this way, FIG. 22 illustrates the theoretical and architectural foundation by which CAFLAE distinguishes and resolves different types of uncertainty, thereby improving the trustworthiness and adaptability of AI-enabled interspecies communication systems.

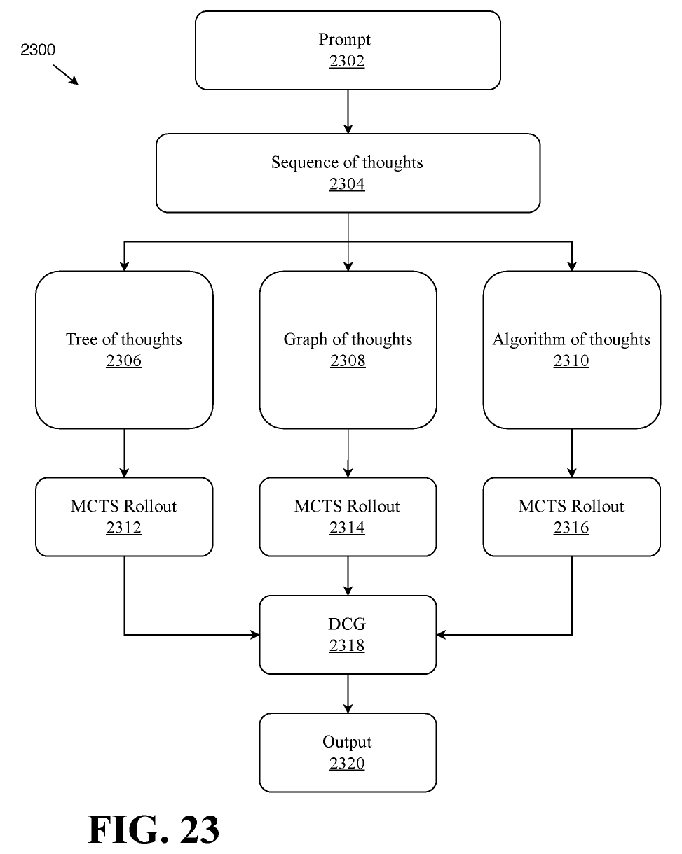

FIG. 23 is a block diagram illustrating an integration framework for chain of thought (CoT), Tree of Thoughts (ToT), Graph of Thoughts (GoT), and Algorithm of Thoughts (AoT) with a distributed computational graph (DCG) and Monte Carlo Tree Search (MCTS), in accordance with one or more embodiments. This depicts how different structured reasoning paradigms can be orchestrated under a unified architecture to support complex, multi-agent, and multimodal decision-making tasks.

A prompt node 2302 represents the input received by the system, which may consist of a user query, animal vocalization, or AI-generated internal goal. The prompt is processed into a sequence of thoughts 2304, which represents a linear reasoning trace akin to traditional chain of thought (CoT) processing. This sequence is then branched into three parallel speculative reasoning modes: tree of thoughts (ToT) module 2306 instantiates a branching structure of reasoning paths based on the input prompt. Each node in the tree corresponds to an intermediate reasoning step or hypothesis, and branches represent alternative continuations. This enables the system to explore divergent strategies in parallel. The graph of thoughts (GoT) module 2308 constructs a general graph-based representation of reasoning, where nodes correspond to semantic or symbolic subgoals and edges denote logical or temporal dependencies. Unlike ToT, GoT allows for merging of paths, recombination of substructures, and backtracking between convergent ideas.

The algorithm of thoughts (AoT) module 2310 represents the evolution of not just reasoning outputs, but reasoning strategies themselves. It treats reasoning graphs as mutable programs, allowing the system to alter control flow, reweight operations, or dynamically mutate inference templates. AoT captures meta-reasoning by enabling structural optimization of the reasoning process over time.

Each of these modules independently connects to a corresponding MCTS Rollout Engine 2312, 2314, 2316, which applies Monte Carlo Tree Search to evaluate paths within ToT, subgraphs within GoT, or programs within AoT. The MCTS rollout engine performs iterative exploration and exploitation, guided by learned or heuristic value functions, salience metrics, and outcome feedback.

Outputs from all MCTS modules are input to the Distributed Computational Graph (DCG) engine 2318. The DCG engine provides a runtime orchestration substrate where reasoning components are expressed as composable subgraphs. Nodes in the DCG correspond to operations such as semantic transformations, symbolic queries, sub-agent calls, or rule applications. Edges define data flow and decision dependencies. The DCG enables introspection, intermediate checkpointing, and interoperability across reasoning modalities.

The final reasoning output is produced by the output module 2320, which may include a communication action (e.g., response generation, robotic instruction, or animal feedback cue), as well as a traceable justification pathway drawn from the DCG and MCTS rollout histories. In this way, FIG. 23 illustrates how CoT, ToT, GoT, and AoT can be instantiated within a unified decision framework that supports symbolic reasoning, dynamic branching, structured learning, and probabilistic search, all underpinned by DCG-MCTS integration.

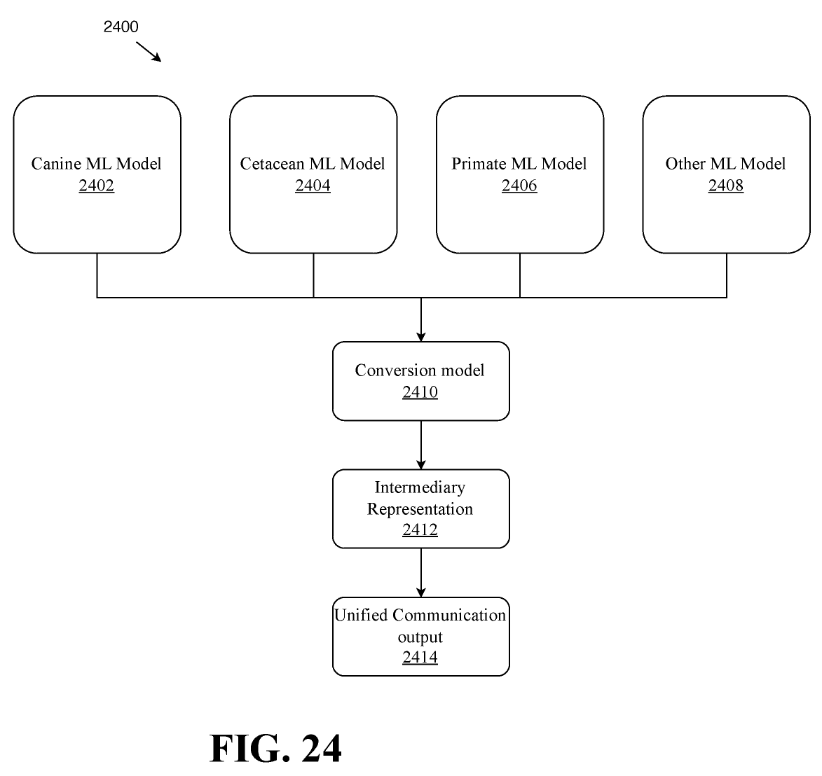

FIG. 24 is a block diagram illustrating a multi-species machine learning (ML) architecture for interspecies communication, in accordance with one or more embodiments. The system 2400 shown in FIG. 24 supports species-specific interpretation pipelines and conversion mechanisms for standardized, cross-species communication. The architecture begins with a set of species-specific machine learning models, each tuned to the communicative traits of a target species: a canine machine learning model 2402 is trained on canine vocalization, posture and neural data; a cetacean machine learning model 2404 adapted to interpret underwater click trains, song patterns, and motion sequences from dolphins and whales; a primate machine learning model 2406 incorporating gesture, facial expression, and vocal inflection data for non-human primates; and a other machine learning model 2408, which may include birds, elephants, or AI agents, using domain-specific training corpora and behavioral data. Each ML model (2402–2408) receives multimodal input (e.g., audio, video, neural signals) from its respective species and processes the data into an internal, intermediate semantic representation. These species-specific representations are then routed to a conversion model 2410.

The conversion model 2410 is a neural translation framework trained to map species-specific semantic structures into a unified latent space. In one or more embodiments, the conversion model is implemented using transformer-based sequence-to-sequence architectures or neuro-symbolic encoders that learn cross-species embeddings. It operates bidirectionally, supporting both input normalization and output re-expansion for downstream response generation.

The output of the conversion model is passed into an intermediary representation layer 2412. This layer acts as a centralized semantic buffer, maintaining agnostic, species-independent representation of communicative intent. This intermediary representation allows for routing to multiple target species or system modules (e.g., planners, translators, dashboards) while ensuring semantic coherence and interpretability.

Finally, the intermediary representation is delivered to a Unified Communication Output 2414. This output module translates the normalized content into appropriate formats for the receiving species or user group. For example, it may generate natural-sounding vocalizations for dogs, underwater audio pulses for dolphins, visual cues for humans, or symbolic commands for robotic agents.

In some embodiments, system 2400 may further incorporate a species detection and model selection module, which automatically identifies the species origin of incoming communication signals using classifiers trained on spectral, biometric, or linguistic features. Based on the detection, the system dynamically selects the corresponding ML model from among models 2402–2408, enabling real-time, multi-species interaction in heterogeneous environments.

In this way, FIG. 24 illustrates how modular, species-specific ML systems may be orchestrated into a scalable and extensible communication architecture that supports dynamic translation, adaptive feedback, and seamless multi-species interoperability.

### Exemplary Computing Environment

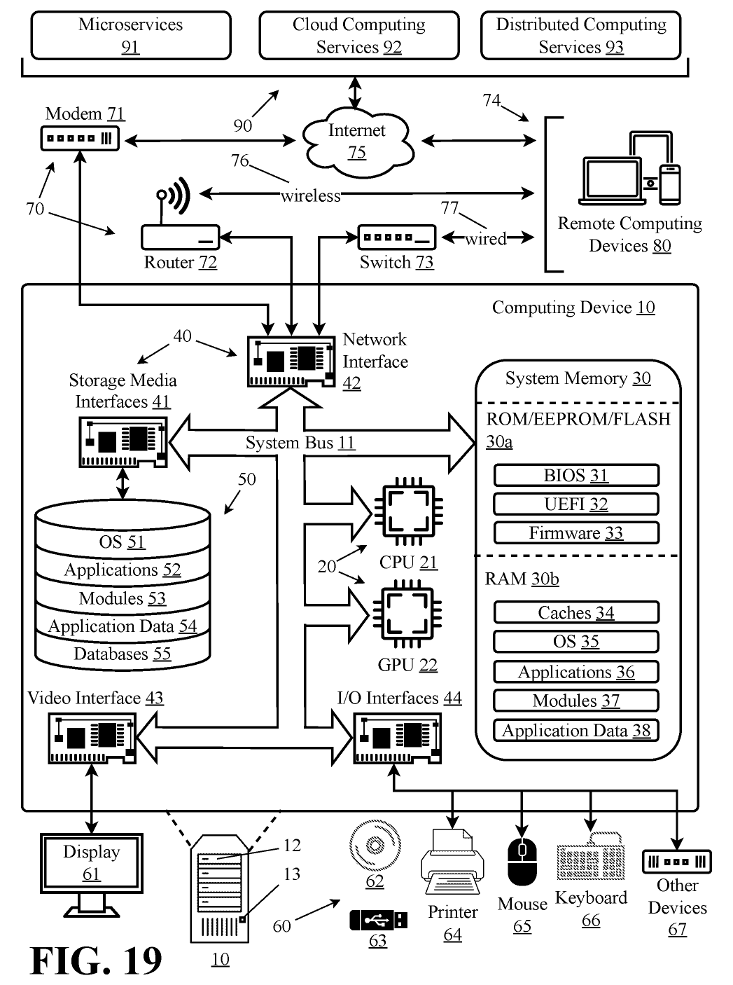

FIG. 19 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure. The system memory 30 and/or other memories can include a non-transitory computer-readable medium.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid-state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, BOSQL databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that enables packaging and running applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containers or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, gRPC, or message queues such as Kafka. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for AI-enabled interspecies communication, comprising:
a computing device comprising at least a memory and a processor; and
a plurality of programming instructions that, when operating on the processor, cause the computing device to:
receive first communication data from a first species;
receive second communication data from a second species;
process the first communication data and second communication data through a machine-learning system, wherein the machine-learning system is configured to:
parse the first communication data and second communication data to derive one or more linguistical patterns;
perform a Monte Carlo Tree Search (MCTS) process to evaluate the one or more linguistical patterns that were derived;
rank the one or more linguistical patterns based on the evaluating;
convert a highest-ranked linguistical pattern corresponding to the first species to derive a converted linguistical pattern corresponding to the second species;
convert a highest ranked linguistical pattern corresponding to the second species to derive a converted linguistical pattern corresponding to the first species;
send the converted linguistical pattern corresponding to the first species to a first output element; and
send the converted linguistical pattern corresponding to the second species to a second output element.

2. The system of claim 1, wherein at least one of the first output element and the second output element comprise an underwater transducer.

3. The system of claim 1, wherein at least one of the first output element and the second output element comprise an electronic display.

4. The system of claim 1, wherein at least one of the first output element and the second output element comprise an acoustic transducer.

5. The system of claim 1, wherein the plurality of programming instructions further includes instructions to perform a super-exponential regret minimization process as part of the MCTS process.

6. The system of claim 1, wherein the plurality of programming instructions further includes instructions to:
obtain first vocalization data from the first species;
obtain second vocalization data from the second species;
obtain first brainwave data from the first species;
obtain second brainwave data from the second species;
obtain first movement data from the first species;
obtain second movement data from the second species; and
provide the first vocalization data, second vocalization data, first brainwave data, second brainwave data, first movement data, second movement data, as input data to a Multimodal Temporal Segmentation Module (MTSM) to generate one or more sliding time windows pertaining to the input data.

7. The system of claim 6, wherein the plurality of programming instructions further includes instructions to render and present a real-time orchestration dashboard on an electronic display that is coupled to the system, wherein the real-time orchestration dashboard includes a rendering of a geospatial view, a behavioral stream display, and a multimodal correlation display.

8. The system of claim 7, wherein the plurality of programming instructions further includes instructions to render and present an alert message on the real-time orchestration dashboard.

9. The system of claim 8, wherein the plurality of programming instructions further includes instructions to render and present a recommendation action on the real-time orchestration dashboard, wherein the recommendation action is based on the alert message.

10. The system of claim 1, wherein the plurality of programming instructions further includes instructions to send the converted linguistical pattern corresponding to the first species and send the converted linguistical pattern corresponding to the second species using a half-duplex process.

11. The system of claim 10, wherein the plurality of programming instructions further includes instructions to implement a turn-based half-duplex process.

12. A method for AI-enabled interspecies communication, comprising:
receiving first communication data from a first species;
receiving second communication data from a second species;
processing the first communication data and second communication data through a machine-learning system, wherein the machine-learning system is configured to:
parse the first communication data and second communication data to derive one or more linguistical patterns;
perform a Monte Carlo Tree Search (MCTS) process to evaluate the one or more linguistical patterns that were derived;
rank the one or more linguistical patterns based on the evaluating;
convert a highest ranked linguistical pattern corresponding to the first species to derive a converted linguistical pattern corresponding to the second species;
convert a highest ranked linguistical pattern corresponding to the second species to derive a converted linguistical pattern corresponding to the first species;
send the converted linguistical pattern corresponding to the first species to a first output element; and
send the converted linguistical pattern corresponding to the second species to a second output element.

13. The method of claim 12, further comprising performing a super-exponential regret minimization process as part of the MCTS process.

14. The method of claim 12, further comprising:
obtaining first vocalization data from the first species;
obtaining second vocalization data from the second species;
obtaining first brainwave data from the first species;
obtaining second brainwave data from the second species;
obtaining first movement data from the first species;
obtaining second movement data from the second species; and
providing the first vocalization data, second vocalization data, first brainwave data, second brainwave data, first movement data, second movement data, as input data to a Multimodal Temporal Segmentation Module (MTSM) to generate one or more sliding time windows pertaining to the input data.

15. The method of claim 14, further comprising rendering and presenting a real-time orchestration dashboard on an electronic display, wherein the real-time orchestration dashboard includes a rendering of a geospatial view, a behavioral stream display, and a multimodal correlation display.

16. The method of claim 15, further comprising rendering and presenting an alert message on the real-time orchestration dashboard.

17. The method of claim 16, further comprising rendering and presenting a recommendation action on the real-time orchestration dashboard, wherein the recommendation action is based on the alert message.

18. The method of claim 12, further comprising sending the converted linguistical pattern corresponding to the first species and sending the converted linguistical pattern corresponding to the second species using a half-duplex process.
